(19) United States
(12) Patent Application Publication
(10) Pub. No.: US 2024/0269707 A1
(43) Pub. Date: Aug. 15, 2024

(54) EXCITATION DEVICE, VIBRATION DEVICE, VEHICLE, CONTROL METHOD, AND COMPUTER PROGRAM

(71) Applicant: Murata Manufacturing Co., Ltd., Nagaokakyo-shi (JP)

(72) Inventors: Noritaka KISHI, Nagaokakyo-shi (JP); Takahide NAKADOI, Nagaokakyo-shi (JP)

(21) Appl. No.: 18/637,600

(22) Filed: Apr. 17, 2024

Related U.S. Application Data
(63) Continuation of application No. PCT/JP2022/026973, filed on Jul. 7, 2022.

(30) Foreign Application Priority Data
Nov. 10, 2021 (JP) 2021-183593

(51) Int. Cl. B06B 1/02; B06B 1/06

(52) U.S. Cl. CPC B06B 1/0284; B06B 1/0644; B06B 2201/70

(57) ABSTRACT

An excitation device includes an output circuit to output a drive signal having a frequency component to drive a piezoelectric element to vibrate an object using a vibrating body, and a control circuit including vibration modes to control the output circuit to apply to the piezoelectric element a drive signal having a frequency based on a resonant frequency of a vibrator including the object, the vibrating body, and the piezoelectric element, the modes including a predetermined vibration mode in which the frequency of the drive signal is about 1/(2n+1) times or about (2n+1) times the resonant frequency of the vibrator, and n is a positive integer.

### CROSS REFERENCE TO RELATED APPLICATIONS

This application claims the benefit of priority to Japanese Patent Application No. 2021-183593 filed on Nov. 10, 2021 and is a Continuation Application of PCT Application No. PCT/JP2022/026973 filed on Jul. 7, 2022. The entire contents of each application are hereby incorporated herein by reference.

### BACKGROUND OF THE INVENTION

### 1. Field of the Invention

The present disclosure relates to an excitation device, a vibration device, a vehicle, a control method, and a computer program.

### 2. Description of the Related Art

There have been studies on technologies to remove foreign matter adhering to a lens or a cover disposed in front of a sensor of an imaging device or the like. For example, U.S. Patent Application Publication No. 2020/0282435 discloses a device in which a controller applies drive signals having different frequencies between a heating sequence and a removal sequence to a piezoelectric element, and the piezoelectric element vibrates a top cover.

### SUMMARY OF THE INVENTION

The use of the technology disclosed in U.S. Patent Application Publication No. 2020/0282435 makes it possible to vibrate the piezoelectric element in the heating sequence or removal sequence. However, the device needs to not only change the frequency but also control the applied voltage, which may result in complicated control. Furthermore, changing the voltage during control operations may complicate the control of a control system within the device or may reduce power conversion efficiency. U.S. Patent Application Publication No. 2020/0282435 also discloses that the frequency of the heating sequence is set higher than the frequency of the removal sequence. The vibration speed of the top cover increases at high frequencies. Therefore, if dirt or other foreign matter adheres to the top cover, it could accelerate the wear of the top cover coating and shorten the life of the coating.

Example embodiments of the present invention provide excitation devices, vibration devices, vehicles, control methods, and non-transitory computer-readable media including computer programs that each can execute a plurality of vibration modes to apply different vibrations to a target object with a simple configuration.

An excitation device according to an example embodiment of the present disclosure includes an output circuit to output a drive signal including a frequency component to drive a piezoelectric element to vibrate an object using a vibrating body, and a control circuit including a plurality of vibration modes to control the output circuit to apply to the piezoelectric element a drive signal having a frequency based on a resonant frequency of a vibrator including the object, the vibrating body, and the piezoelectric element, in which the plurality of vibration modes include a predetermined vibration mode in which the frequency of the drive signal is set to about 1/(2n+1) times or about (2n+1) times the resonant frequency of the vibrator. Here, n is a positive integer.

A vibration device according to an example embodiment of the present disclosure includes the excitation device, the piezoelectric element, the vibrating body, and the object.

A vehicle according to an example embodiment of the present disclosure includes the excitation device, the piezoelectric element, the vibrating body, the object, and an imaging device.

A method for controlling according to an example embodiment of the present disclosure is a method for controlling an output circuit to output a drive signal having a frequency component to drive a piezoelectric element to vibrate an object using a vibrating body, the method including selecting a predetermined vibration mode from among a plurality of vibration modes to control the output circuit so as to apply to the piezoelectric element a drive signal having a frequency based on a resonant frequency of a vibrator including the object, the vibrating body, and the piezoelectric element, and setting the frequency of the drive signal to about 1/(2n+1) times or about (2n+1) times the resonant frequency of the vibrator in the predetermined vibration mode. Here, n is a positive integer.

A non-transitory computer-readable medium including a computer program according to an example embodiment of the present disclosure causes one or more processors to execute the control method according to another example embodiment of the present disclosure.

Example embodiments of the present disclosure can provide excitation devices, vibration devices, vehicles, control methods, and non-transitory computer-readable media including computer programs that each can execute a plurality of vibration modes to apply different vibrations to a target object with a simple configuration.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a vibration device according to an example embodiment of the present invention.

FIG. 2 is a schematic cross-sectional view of a configuration of an imaging unit according to an example embodiment of the present invention.

FIG. 3 is a schematic block diagram of a vibration circuit according to an example embodiment of the present invention.

FIG. 4 is a schematic circuit diagram of the vibration circuit according to an example embodiment of the present invention.

FIG. 5 is a graph showing the relationship between a frequency of a drive signal applied to a piezoelectric element and impedance.

FIG. 6 is a schematic diagram showing an example of the relationship between a sliding angle and adhesion energy.

FIG. 7 is a schematic diagram showing an example of the relationship between the sliding angle and vibration acceleration.

FIG. 8 is a timing chart showing input and output signals of each element of an excitation circuit.

FIG. 9A is a graph showing a temporal change in a drive signal having a predetermined resonant frequency applied to the piezoelectric element and a temporal change in a displacement amount of a protective cover when the piezoelectric element is driven at the frequency.

FIG. 9B is a graph showing a temporal change in a drive signal having a predetermined resonant frequency applied to the piezoelectric element and a temporal change in the displacement amount of the protective cover when the piezoelectric element is driven at a frequency that is about ⅓ times the frequency.

FIG. 10A is a graph showing an example of control using a first sweep method for a control circuit to determine the resonant frequency.

FIG. 10B is a graph showing an example of control using a second sweep method for the control circuit to determine the resonant frequency.

FIG. 10C is a graph showing an example of control using a third sweep method for the control circuit to determine the resonant frequency.

FIG. 11 is a graph showing the impedance of the piezoelectric element with respect to a switching frequency near the resonant frequency and a phase difference between the voltage applied to the piezoelectric element and a current flowing through the piezoelectric element.

FIG. 12 is a schematic circuit diagram showing a modification of the excitation circuit according to an example embodiment of the present invention.

FIG. 13 is a graph showing an example of the displacement amount of the protective cover according to an frequency of the drive signal.

FIG. 14 is a schematic block diagram of a modification of the vibration circuit according to an example embodiment of the present invention.

FIG. 15A is a graph showing a temporal change in a drive signal having a predetermined resonant frequency applied to the piezoelectric element and a temporal change in a displacement amount of the protective cover when the piezoelectric element is driven at the frequency.

FIG. 15B is a graph showing a temporal change in a drive signal having a predetermined resonant frequency applied to the piezoelectric element and a temporal change in the displacement amount of the protective cover when the piezoelectric element is driven at a frequency that is about ⅓ times the frequency.

FIG. 16 is a graph showing an example of temperature rise characteristics of the protective cover when the piezoelectric element is vibrated.

FIG. 17 is a graph showing an example of a method for controlling a temperature rise of the protective cover using the excitation device in a de-icing mode.

FIG. 18 is a flowchart for explaining vibration processing of the vibration device by the control circuit of the excitation device according to an example embodiment of the present invention.

### DETAILED DESCRIPTION OF THE EXAMPLE EMBODIMENTS

Example embodiments according to the present disclosure will be described below with reference to the drawings. However, the configurations described below are merely examples of the present disclosure, and the present disclosure is not limited to the example embodiments described below. Besides these example embodiments, various changes can be made according to the design and the like without departing from the technical ideas of the present disclosure.

### Example Embodiments

### 1-1. Configuration Example

An excitation device according to an example embodiment of the present disclosure includes an output circuit to output a drive signal including a frequency component to drive a piezoelectric element to vibrate a target object using a vibrating body, and a control circuit including a plurality of vibration modes to control the output circuit to apply a drive signal having a frequency based on a resonant frequency of a vibrator including the piezoelectric element, the vibrating body, and a protective cover to the piezoelectric element. The plurality of vibration modes include a predetermined vibration mode to set the frequency of the drive signal to about 1/(2n+1) times or about (2n+1) times the resonant frequency of the vibrator. Here, n is a positive integer. With this configuration, the excitation device can vibrate the object vibrated by the piezoelectric element in a plurality of vibration modes without having a complicated configuration.

### 1-1-1. Vibration Device

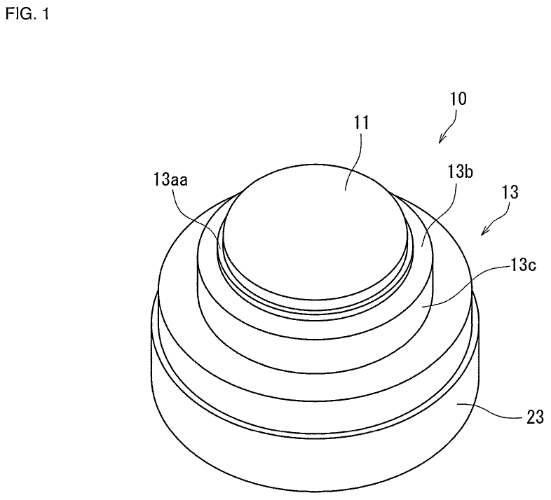

FIG. 1 is a perspective view of a vibration device 10 according to an example embodiment of the present disclosure. The vibration device 10 according to this example embodiment includes a protective cover 11, a vibrating body 13, a piezoelectric element 15, and an excitation circuit 31 to be described later. The vibrating body 13 includes a first cylindrical portion 13a, a spring portion 13b, a second cylindrical portion 13c, and a diaphragm 13d. The vibration device 10 and an imaging unit 100 including the vibration device 10 (to be described in detail later) are examples of a device that is vibrated by the excitation circuit 31 according to this example embodiment to be described later, and are not limited thereto. In this specification, the excitation circuit is hereinafter also referred to as an excitation device. The structure including the protective cover 11, the vibrating body 13, and the piezoelectric element 15 has a predetermined resonant frequency to be described later with respect to the vibration of the piezoelectric element 15. This structure is hereinafter referred to as a vibrator 17.

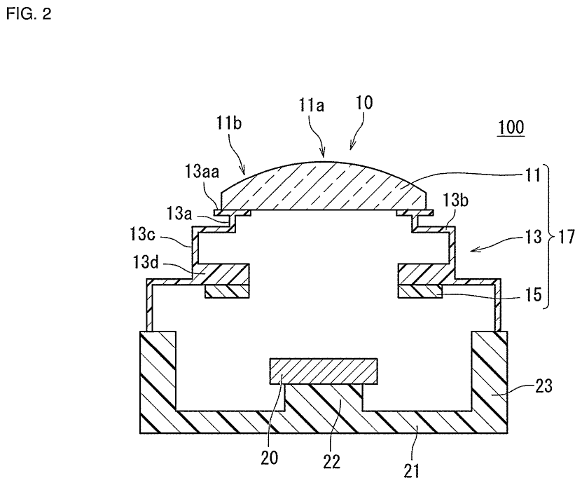

The protective cover 11 transmits light of a predetermined wavelength. The predetermined wavelength is, for example, a wavelength detected by an imaging device 20 (see FIG. 2) of the imaging unit 100. The predetermined wavelength is not limited to a wavelength in the visible light region, but may be a wavelength in the invisible light region.

The protective cover 11 is supported by an end portion of the first cylindrical portion 13a. Specifically, the protective cover 11 has its back surface supported by the first cylindrical portion 13a.

The protective cover 11 has a hemispherical dome shape. The protective cover 11 has a circular shape when viewed from the height direction of the vibration device 10. Note that the shape of the protective cover 11 is not limited to the circular shape. The shape of the protective cover 11 viewed from the height direction of the vibration device 10 may be polygonal, oval, or the like. The protective cover 11 is not limited to the hemispherical dome shape. For example, the protective cover 11 may have a shape formed by connecting cylinders into a hemisphere, or may have a curved shape smaller than a hemisphere. The protective cover 11 may be a flat plate. The protective cover 11 may have a function as an optical element such as a lens.

The first cylindrical portion 13a preferably has a cylindrical shape including one end and the other end. The first cylindrical portion 13a supports the protective cover 11 at one end. For example, the protective cover 11 and the first cylindrical portion 13a are joined. A method for joining the protective cover 11 and the first cylindrical portion 13a is not particularly limited. Examples of the joining method include bonding with an adhesive, welding, fitting, and press-fitting.

In this example embodiment, the first cylindrical portion 13a includes a flange 13aa at one end. The flange 13aa is a plate-shaped structure extending outward from one end of the first cylindrical portion 13a. The flange 13aa preferably has an annular plate shape. The first cylindrical portion 13a has the flange 13aa increase the contact area with the protective cover 11, thus stably supporting the protective cover 11.

The other end of the first cylindrical portion 13a is supported by the elastically deformable spring portion 13b. In other words, the first cylindrical portion 13a is supported by the spring portion 13b on the opposite side to the protective cover 11 side.

The first cylindrical portion 13a is made of a hollow member with a through-hole provided inside. The through-hole is provided in the height direction of the vibration device 10, and has openings provided at one end and the other end of the first cylindrical portion 13a. The first cylindrical portion 13a has a cylindrical shape, for example. The external shape of the first cylindrical portion 13a and the openings of the through-hole are formed in a circular shape when viewed from the height direction of the vibration device 10.

Note that the shape of the first cylindrical portion 13a is not limited to such a cylindrical shape. For example, the first cylindrical portion 13a may have a polygonal cylindrical shape, an elliptical cylindrical shape, or the like.

The material of the first cylindrical portion 13a may be metal, synthetic resin or the like, for example. The material of the first cylindrical portion 13a may also be ceramic, glass, or the like, which can be molded and/or cut. The same applies to the spring portion 13b, the second cylindrical portion 13c, and the diaphragm 13d.

The spring portion 13b supports the first cylindrical portion 13a so as to be displaceable with respect to the second cylindrical portion 13c. The spring portion 13b is a circular plate spring. The spring portion 13b has its inner peripheral portion supporting the other end of the first cylindrical portion 13a. The spring portion 13b has its outer peripheral portion supported by the second cylindrical portion 13c. The outer peripheral shape and inner peripheral shape of the spring portion 13b are circular when viewed from the height direction of the vibration device 10.

Note that the outer peripheral shape and inner peripheral shape of the spring portion 13b are not limited to such a circular shape. The outer peripheral shape and inner peripheral shape of the spring portion 13b may be polygonal or elliptical when viewed from the height direction of the vibration device 10.

The second cylindrical portion 13c has a cylindrical shape with one end and the other end. One end of the second cylindrical portion 13c supports the outer peripheral portion of the spring portion 13b.

The diaphragm 13d is disposed at the other end of the second cylindrical portion 13c.

Note that the second cylindrical portion 13c is not limited to a cylindrical shape. For example, the second cylindrical portion 13c may have a polygonal cylindrical shape, an elliptical cylindrical shape, or the like.

The diaphragm 13d is disposed at the other end of the second cylindrical portion 13c, and vibrates in the height direction of the vibration device 10. Specifically, the diaphragm 13d is disposed at the other end of the second cylindrical portion 13c, that is, on the bottom surface.

The piezoelectric element 15 is provided on the bottom surface (lower surface) of the diaphragm 13d. The diaphragm 13d vibrates as the piezoelectric element 15 vibrates, causing the second cylindrical portion 13c to vibrate in the height direction of the vibration device 10. For example, the piezoelectric element 15 vibrates upon voltage application.

The piezoelectric element 15 has an annular plate shape. The outer peripheral shape and inner peripheral shape of the piezoelectric element 15 are circular when viewed from the height direction of the vibration device 10. Note that the outer peripheral shape and inner peripheral shape of the piezoelectric element 15 are not limited to such a circular shape. The outer peripheral shape and inner peripheral shape of the piezoelectric element 15 viewed from the height direction of the vibration device 10 may be polygonal or elliptical, for example.

The piezoelectric element 15 includes a piezoelectric body and an electrode. Examples of piezoelectric material include suitable piezoelectric ceramics such as barium titanate (BaTiO₃), lead zirconate titanate (PZT: PbTiO₃, PbZrO₃), lead titanate (PbTiO₃), lead metaniobate (PbNb₂O₆), and bismuth titanate (Bi₄Ti₃O₁₂) (K,Na)NbO₃ or suitable piezoelectric single crystals such as LiTaO₃ and LiNbO₃. The electrode may be a Ni electrode, for example. The electrode may be an electrode made of a metal thin film such as Ag or Au, which is formed by a sputtering method. The electrode can be formed by plating or vapor deposition, other than sputtering.

The diaphragm 13d has an annular plate shape. The diaphragm 13d supports the bottom surface of the second cylindrical portion 13c.

The protective cover 11, the first cylindrical portion 13a, the spring portion 13b, and the second cylindrical portion 13c are configured such that the resonant frequency of the protective cover 11 is larger than the resonant frequency of the spring portion 13b. Specifically, the resonant frequency of the protective cover 11 is set larger than the resonant frequency of the spring portion 13b by determining the materials and dimensions of the protective cover 11, the first cylindrical portion 13a, the spring portion 13b, and the second cylindrical portion 13c described above.

The first cylindrical portion 13a, the spring portion 13b, the second cylindrical portion 13c, and the diaphragm 13d are integrally formed. Note that the first cylindrical portion 13a, the spring portion 13b, the second cylindrical portion 13c, and the diaphragm 13d may be formed separately or may be formed as separate members.

As described above, the vibration device 10 includes the excitation circuit 31 that applies a drive signal to the piezoelectric element 15 to cause vibration. The excitation circuit 31 is connected to the piezoelectric element 15 through a power supply conductor, for example. The piezoelectric element 15 vibrates in the height direction of the vibration device 10 based on the drive signal from the excitation circuit 31. The vibration of the piezoelectric element 15 causes the diaphragm 13d to vibrate in the height direction of the vibration device 10, and the diaphragm 13d vibrates the second cylindrical portion 13c in the height direction of the vibration device 10. The vibration of the second cylindrical portion 13c can transmit the vibration of the piezoelectric element 15 to the first cylindrical portion 13a through the spring portion 13b. In the vibration device 10, the protective cover 11 is vibrated by the vibration of the first cylindrical portion 13a, thus removing foreign matter such as raindrops adhering to the protective cover 11.

The excitation circuit 31 applies a drive signal to the piezoelectric element 15 so that the first cylindrical portion 13a and the second cylindrical portion 13c vibrate in the height direction of the vibration device 10 in opposite phases. The excitation circuit 31 can vibrate the vibration device 10 in a vibration mode other than the mode in which the first cylindrical portion 13a and the second cylindrical portion 13c vibrate in the height direction of the vibration device 10 in opposite phases based on the drive signal applied to the piezoelectric element 15.

FIG. 2 is a schematic cross-sectional view of a configuration of the imaging unit 100 according to this example embodiment. FIG. 2 is a cross-sectional view taken along a plane passing through the center of the vibration device 10 of FIG. 1 when viewed from the height direction of the vibration device 10. The imaging unit 100 is a unit that is attached to the front or rear of a vehicle, for example, to capture images of an object. Note that the imaging unit 100 may be attached to a ship, an aircraft, or the like, other than a vehicle.

The imaging unit 100 includes the vibration device 10 and the imaging device 20. The imaging device 20 is housed inside the vibration device 10. The imaging device 20 includes an imaging element such as a CMOS and a CCD, for example. The imaging device 20 can form an image based on light transmitted through the protective cover 11. The imaging unit 100 further includes a base member 21, a main body member 22, and a support member 23. The main body member 22 has a circular plate shape. The base member 21 is located at the center of the upper surface of the main body member 22. The imaging device 20 is fixed on the base member 21. The support member 23 extends upward from the outer periphery of the main body member 22. The vibration device 10 is supported by the support member 23. The imaging unit 100 may include an optical member such as one or more lenses between the protective cover 11 and the imaging device 20.

When the imaging unit 100 is attached to a vehicle or the like and used outdoors, foreign matter such as raindrops, mud, and dust may adhere to the protective cover 11 that covers the imaging device 20, and the protective cover 11 may freeze. The vibration device 10 can generate vibration to remove foreign matter such as raindrops adhering to the protective cover 11 or vibration to prevent freezing.

### 1-1-2. Vibration Circuit

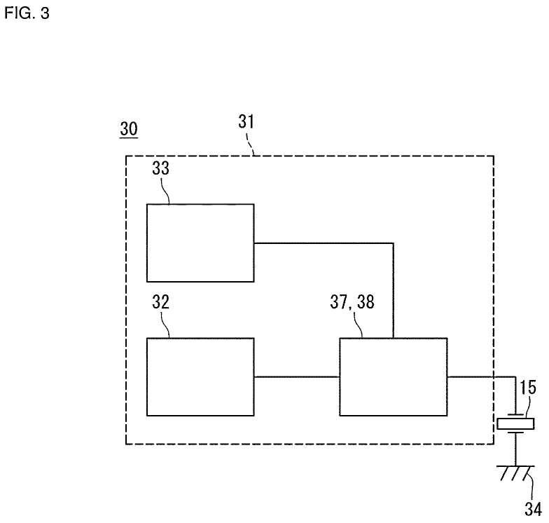

FIG. 3 is a schematic block diagram of a vibration circuit 30 including the excitation circuit 31 and the piezoelectric element 15 according to this example embodiment. As shown in FIG. 3, the excitation circuit 31 includes a control circuit 32, a DC power supply 33, and an output circuit 37. The excitation circuit 31 may further include a current detection circuit 38. As will be described in detail later, in the excitation circuit 31 according to this example embodiment, a voltage supplied from the DC power supply 33 can be controlled by the control circuit 32 to be applied as a drive signal having a frequency component to the piezoelectric element 15 through the output circuit 37. The control circuit 32 of the excitation circuit 31 can determine the resonant frequency of the vibrator 17 by the current detection circuit 38 detecting the magnitude of the current outputted from the output circuit 37 to the piezoelectric element 15, and thus can appropriately control the frequency of the drive signal.

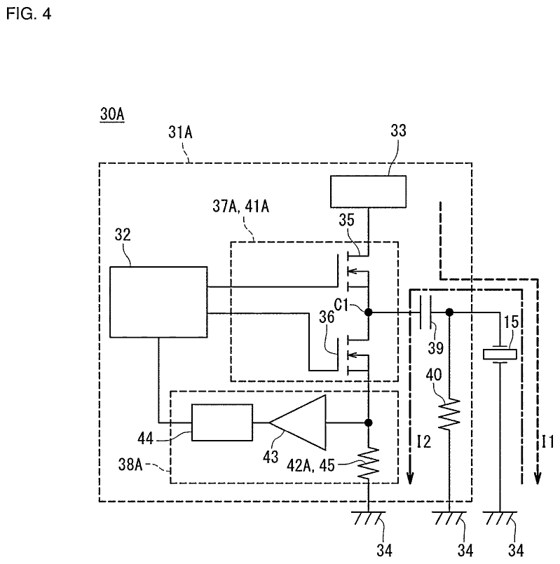

FIG. 4 is a schematic circuit diagram as an example of a vibration circuit 30A according to FIG. 3. An excitation circuit 31A includes a control circuit 32, a DC power supply 33, an output circuit 37A including a series circuit of a first switch 35 and a second switch 36, a current detection circuit 38A, a capacitor 39, and a resistor 40.

The control circuit 32 is configured or programmed to control switching frequencies of the first switch 35 and the second switch 36. The control circuit 32 includes a general-purpose processor such as a CPU or an MPU that implements predetermined functions by executing programs. The control circuit 32 is configured to be able to communicate with a storage device, and carries out various types of processing in the control circuit 32 or the like, such as switching processing of the first switch 35 and the second switch 36, by calling and executing an arithmetic program and the like stored in the storage device. The control circuit 32 is not limited to a configuration in which hardware resources and software cooperate to realize a predetermined function, but may be a hardware circuit specifically designed to realize a predetermined function. Specifically, the control circuit 32 can be realized by various processors such as GPU, FPGA, DSP, ASIC, or the like, besides CPU and MPU. Such a control circuit 32 may be configured using a signal processing circuit that is a semiconductor integrated circuit, for example.

The DC power supply 33 has an output end that generates a predetermined voltage between the DC power supply 33 and a reference potential 34. The DC power supply 33 may be a battery, for example, and the output end may be a positive terminal of the battery. Note that the DC power supply 33 may be a known device that can apply a predetermined voltage to the piezoelectric element 15 in combination with the reference potential 34.

The reference potential 34 may be, for example, the ground or body earth connected to a negative terminal of the battery.

The output circuit 37A is connected to the DC power supply 33. As shown in FIG. 4, in this example embodiment, the output circuit 37A is connected to the reference potential 34 through a current-voltage conversion circuit 42A to be described later. The output circuit 37A includes the series circuit of the first switch 35 and the second switch 36 connected to the DC power supply 33, as described above. The series circuit of the first switch 35 and the second switch 36 is also referred to herein as a “first leg 41A”. In the first leg 41A of the output circuit 37A, a connection point Cl between the first switch 35 and the second switch 36 is connected to the piezoelectric element 15 through the capacitor 39.

The first switch 35 is a metal oxide semiconductor field effect transistor (MOSFET), for example, but is not limited thereto. The first switch 35 includes one end (for example, a source) and the other end (for example, a drain). One end of the first switch 35 is connected to the DC power supply 33. The other end of the first switch 35 is connected to the second switch 36. The other end of the first switch 35 is also connected to the piezoelectric element 15 through the capacitor 39. The control circuit 32 is connected to a control end (for example, a gate) of the first switch 35, and can switch the first switch 35 on and off as described above. Specifically, the control circuit 32 can control the first switch 35 to electrically conduct/open the electric path between the DC power supply 33 connected to the first switch 35 and the piezoelectric element 15 by switching the first switch 35 on and off.

As with the first switch 35, the second switch 36 is a MOSFET, for example, but is not limited thereto. The second switch 36 has one end (for example, a source) and the other end (for example, a drain). One end of the second switch 36 is connected to the other end of the first switch 35. Specifically, one end of the second switch 36 is connected to the piezoelectric element 15 through the capacitor 39, as in the case of the other end of the first switch 35. The other end of the second switch 36 is connected to the reference potential 34 through a current-voltage conversion element 45 of the current-voltage conversion circuit 42A. The control circuit 32 is connected to a control end (for example, a gate) of the second switch 36, and can switch the second switch 36 on and off as described above. Specifically, the control circuit 32 can control the second switch 36 to electrically conduct/open the electric path between the piezoelectric element 15 connected to the second switch 36 and the reference potential 34 by switching the second switch 36 on and off.

The current detection circuit 38A can detect at least one of the current flowing through the first switch 35 and the current flowing through the second switch 36, and can output a detection signal indicating the magnitude of the detected current to the control circuit 32. The current detection circuit 38A according to this example embodiment includes the current-voltage conversion circuit 42A, a low pass filter 43, and an analog/digital conversion circuit (AD conversion circuit) 44.

The current-voltage conversion circuit 42A includes the current-voltage conversion element 45. The current-voltage conversion element 45 can convert the current flowing through the current-voltage conversion element 45 into a voltage corresponding to the magnitude of the current flowing through the current-voltage conversion element 45. The current-voltage conversion element 45 may be provided to detect the current flowing through the first switch 35 or the current flowing through the second switch 36, for example, as a voltage. In this example embodiment, the current-voltage conversion element 45 is connected between the second switch 36 and the reference potential 34. The current-voltage conversion element 45 can detect the current flowing from the piezoelectric element 15 to the reference potential 34 through the second switch 36. The current-voltage conversion circuit 42A may have two current-voltage conversion elements and may be configured to have one of the two current-voltage conversion elements detect the current flowing through the first switch 35 and the other of the two current-voltage conversion elements detect the current flowing through the second switch 36. In this example embodiment, the current-voltage conversion element 45 is a resistor (shunt resistor) having a predetermined resistance value. The current-voltage conversion element 45 is not limited to the shunt resistor but may be a Hall element. In this case, the current-voltage conversion element 45 may be disposed near the second switch 36 so as to detect a magnetic field caused by the current flowing through the second switch 36. Therefore, the current-voltage conversion element 45 may be a known element that can convert current into voltage.

The low pass filter 43 is a filter circuit that removes a signal having a frequency component higher than a cutoff frequency. In this example embodiment, the low pass filter 43 is connected to a connection point between the current-voltage conversion element 45 and the second switch 36. The low pass filter 43 smooths the voltage inputted from the current-voltage conversion circuit 42A and outputs the voltage to the AD conversion circuit 44.

The AD conversion circuit 44 is a circuit that converts the voltage (analog signal) smoothed by the low pass filter 43 into a digital signal that can be inputted to the control circuit 32. The AD conversion circuit 44 outputs the digital signal as a detection signal to the control circuit 32. The current detection circuit 38A may be configured to output the voltage smoothed by the low pass filter 43 as the detection signal to the control circuit 32 without including the AD conversion circuit 44.

The current detection circuit 38A according to this example embodiment outputs a detection signal, which is a digital signal generated based on the magnitude of the current flowing through the second switch 36, to the control circuit 32, but is not limited thereto. For example, the current detection circuit 38A may include only the current-voltage conversion circuit 42A and the low pass filter 43, and may be configured to output a detection signal that is an analog signal, instead of a digital signal, to the control circuit 32.

As described above, the piezoelectric element 15 includes the piezoelectric body and the electrode. The piezoelectric element 15 has one end and the other end, and has one end connected to the capacitor 39 and the other end connected to the reference potential 34. Specifically, an electrode on one end side of the piezoelectric element 15 is connected to the capacitor 39, while an electrode on the other end side of the piezoelectric element 15 is connected to the reference potential 34.

The capacitor 39 can store electric charges based on the voltage applied by the DC power supply 33 in a first state to be described later. The capacitor 39 can release the stored charges to the reference potential 34 through the second switch 36 in a second state to be described later. Therefore, in the excitation circuit 31A, the control circuit 32 controls the switching processing of the first switch 35 and the second switch 36, thus allowing a current I₁ and a current I₂ to flow through the vibration circuit 30A as described later.

The resistor 40 is connected between the connection point between the piezoelectric element 15 and the capacitor 39 and the reference potential 34. Upon completion of the switching processing by the control circuit 32, the one end side and the other end side of the piezoelectric element 15 are at the same potential since the piezoelectric element 15 has one end connected to the reference potential 34 through the resistor 40.

The excitation device 31 according to the present disclosure is not limited to the above circuit configuration. For example, the output circuit 37A has a half-bridge configuration using two switches, but may have a full-bridge configuration using four switches. The current detection circuit 38A uses a shunt resistor to detect the current flowing through the second switch as a voltage, but may use a Hall element. The excitation device 31 is not limited to the circuit configuration described above, and can use an existing configuration.

### 1-2. Operation Example

An operation example of the excitation circuit 31A according to this example embodiment will be described with reference to FIG. 4. As described above, FIG. 4 shows the vibration circuit 30A including the excitation circuit 31A and the piezoelectric element 15.

The control circuit 32 of the excitation circuit 31A according to this example embodiment executes switching processing to complementarily switch the first switch 35 and the second switch 36 at the switching frequency. Specifically, the control circuit 32 controls the first switch 35 and the second switch 36 to be in a state where the second switch 36 is off when the first switch 35 is on (referred to as a “first state” as appropriate). The control circuit 32 also controls the first switch 35 and the second switch 36 to be in a state where the second switch 36 is on when the first switch 35 is off (referred to as a “second state” as appropriate). The control circuit 32 applies a voltage (for example, a rectangular voltage) having a frequency corresponding to the switching frequency, as a drive signal, to the piezoelectric element 15, based on a predetermined voltage from the DC power supply 33 by complementarily switching the first switch 35 and the second switch 36.

In the first state, the current I₁ flows through the first switch 35 in the vibration circuit 30A. The current I₁ is indicated by the dashed arrow in FIG. 4. As shown in FIG. 4, the current I₁ flows from the DC power supply 33 to the piezoelectric element 15 through the first switch 35. Therefore, a voltage having a high potential on the excitation circuit 31A side is applied to the piezoelectric element 15.

In the vibration circuit 30A, when a voltage is applied to the piezoelectric element 15 in the first state, positive charges are accumulated on the output circuit 37A side and negative charges are accumulated on the reference potential 34 side in the capacitor 39 interposed between the output circuit 37A and the piezoelectric element 15. When the control circuit 32 changes the output circuit 37A from the first state to the second state, the capacitor 39 and the piezoelectric element 15 release the charges. In the second state, the released charges flow as a current I₂ into the vibration circuit 30A through the second switch 36. The current I₂ is indicated by the dashed-dotted arrow in FIG. 4. As shown in FIG. 4, the current I₂ flows from the piezoelectric element 15 to the reference potential 34 through the second switch. In the capacitor 39, negative charges are accumulated on the output circuit 37A side and positive charges are accumulated on the piezoelectric element 15 side. Therefore, a voltage having a low potential on the excitation circuit 31A side is applied to the piezoelectric element 15.

The control circuit 32 can thus apply a voltage whose polarity is inverted at a predetermined frequency to the piezoelectric element 15 by switching the first switch 35 and the second switch 36. Therefore, the vibration circuit 30A according to this example embodiment can reduce the possibility of ion migration occurring in the piezoelectric element 15.

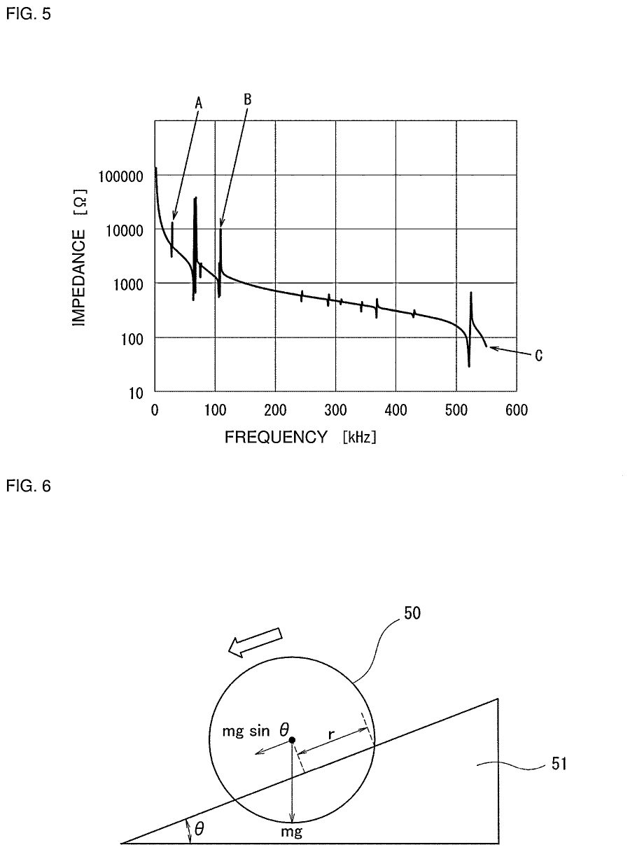

When a drive signal (for example, a rectangular voltage having a predetermined frequency) is applied to the piezoelectric element 15, the impedance of the piezoelectric element 15 changes with the frequency of the drive signal. For example, FIG. 5 is a graph showing the relationship between the frequency of the drive signal applied to the piezoelectric element 15 and the impedance. As shown in FIG. 5, the piezoelectric element 15 has a plurality of frequencies at which the impedance locally decreases. These frequencies correspond to the resonant frequencies of the vibrator 17. In the vibration device 10 according to this example embodiment, the resonant frequencies exist at about 31 kHz (arrow A section), about 110 kHz (arrow B section), and about 550 kHz (arrow C section), for example. When a voltage (drive signal) having a frequency corresponding to any one of these resonant frequencies is applied, the piezoelectric element 15 vibrates the protective cover 11 in a vibration mode that differs for each frequency. For example, when a voltage having a frequency of about 31 kHz is applied, the piezoelectric element 15 vibrates the protective cover 11 using the vibrating body 13 in a first removal mode, which is a vibration mode for vibrating the entire protective cover 11. The first removal mode is a vibration mode capable of atomizing and removing foreign matter such as droplets adhering to the protective cover 11. When a voltage having a frequency of about 110 kHz is applied, the piezoelectric element 15 vibrates the protective cover 11 using the vibrating body 13 in a second removal mode, which is a vibration mode for vibrating the center of the protective cover 11 more than the peripheral portion. The vibration in the second removal mode is a vibration corresponding to the resonant frequency of the protective cover 11. When a voltage having a frequency of about 550 kHz is applied, the piezoelectric element 15 vibrates the protective cover 11 using the vibrating body 13 or the like in a de-icing mode, which is a vibration mode that facilitates temperature rise in the protective cover 11. The vibration around about 550 kHz causes the protective cover 11 to vibrate in a higher-order vibration mode with more nodes than the vibration at about 110 kHz. In the de-icing mode, a large amount of electric power is applied to the piezoelectric element 15 since the impedance of the piezoelectric element 15 is small, thus making it possible to quickly raise the temperature of the protective cover 11. The above resonant frequency is just an example, and may be changed depending on the shape, material, and the like of the vibration device 10. The piezoelectric element 15 may be configured to apply vibration to the protective cover 11 in modes other than those described above.

In addition to the vibration modes having different frequencies of the drive signal for vibrating the piezoelectric element 15, the vibration device 10 according to this example embodiment further has a vibration mode having different vibration accelerations of the protective cover 11. The vibration modes include a strong vibration mode in which the amplitude of vibration of the protective cover 11 is large and a weak vibration mode in which the amplitude of vibration of the protective cover 11 is smaller than in the strong vibration mode, for example, in the first removal mode. When the excitation device 31 vibrates the piezoelectric element 15 in the strong vibration mode, foreign matter such as droplets adhering to the protective cover 11, for example, can be atomized and removed. When the excitation device 31 of the vibration device 10 vibrates the piezoelectric element 15 in the weak vibration mode, foreign matter such as droplets adhering to the protective cover 11 can slide off. The strong vibration mode is also called a first vibration mode. The weak vibration mode is also called a second vibration mode. Such a difference in vibration mode can be caused by a difference in the frequency of vibration generated in the protective cover 11 (that is, a difference in resonant frequency), a difference in the vibration amplitude generated in the protective cover 11, or a combination thereof.

As described above, when the excitation device 31 drives the piezoelectric element 15 in the first removal mode, the protective cover 11 entirely vibrates in a vertical direction. Here, the vertical direction is a direction along the height direction of the vibration device 10. Therefore, the vibration amplitude of a central portion 11a of the protective cover 11 when viewed from the height direction of the vibration device 10 of FIG. 1 is approximately the same as the vibration amplitude of a peripheral portion 11b of the protective cover 11. Hereinafter, the central portion 11a of the protective cover 11 is also referred to as a top portion 11a of the protective cover 11. The peripheral portion 11b of the protective cover 11 is also referred to as an end portion 11b of the protective cover 11. Note that the first removal mode includes the strong vibration mode and the weak vibration mode described above.

When atomizing and removing foreign matter such as water droplets adhering to the protective cover 11, it is preferable that the excitation device 31 vibrates the piezoelectric element 15 so as to cause large displacement of the protective cover 11, in order to increase the range in which the foreign matter can be removed in the protective cover 11. It is also preferable that the excitation device 31 vibrates the piezoelectric element 15 so as to reduce the distribution of displacement of the protective cover 11. The distribution of displacement of the protective cover 11 is a value that can be expressed by Formula V_{dist}=a_{center}/a_{edge}. V_{dist} is the distribution of displacement of the protective cover 11. Hereinafter, the displacement distribution is also referred to as vibration distribution. a_{center} is the amplitude of vibration of the top portion 11a of the protective cover 11. a_{edge} is the amplitude of vibration of the end portion 11b of the protective cover 11. When the displacement distribution is large, a coating applied to the protective cover 11 is locally worn due to friction with foreign matter such as mud adhering to the protective cover 11 caused by vibration in areas where the amount of displacement is large. In order to prevent the wear of the coating of the protective cover 11 due to vibration, it is preferable that the displacement is uniform between the top portion 11a and the end portion 11b, or that the displacement is larger on the end portion 11b side than on the top portion 11a side. That is, it is preferable that the value of V_{dist} described above is small. By vibrating the protective cover 11 as described above, it is possible to remove foreign matter adhering to the protective cover 11 while reducing the wear of the top portion of the protective cover 11, which is important in imaging with the imaging device 20. Therefore, the excitation device 31 can effectively remove the foreign matter adhering to the protective cover 11 by using the first removal mode.

When melting ice adhering to the protective cover 11, it is preferable that the excitation device 31 vibrates the piezoelectric element 15 so as to reduce the amount of displacement of the protective cover 11, in order to reduce or prevent the wear of the coating of the protective cover 11 due to vibration. It is also preferable that the excitation device 31 de-ices the top portion 11a of the protective cover 11 before the end portion 11b of the protective cover 11, in order to secure the field of view of the imaging device 20, which is important in imaging with the imaging device 20. The excitation device 31 can vibrate the protective cover 11 by driving the piezoelectric element 15 in the de-icing mode described above so that the protective cover 11 generates heat and melts the ice adhering to the protective cover 11. For more efficient de-icing, it is preferable that the excitation device 31 drives the piezoelectric element 15 in the de-icing mode so as to satisfy V_{dist_heat}>V_{dist_st} and a_{center_heat}<a_{center_st} compared to the strong vibration mode. V_{dist_heat} is the distribution of vibration of the protective cover 11 in the de-icing mode. V_{dist_st} is the distribution of vibration of the protective cover 11 in the strong vibration mode. a_{center_heat} is the amplitude of vibration of the top portion 11a of the protective cover 11 in the de-icing mode. a_{center_st} is the amplitude of vibration of the top portion 11a of the protective cover 11 in the strong vibration mode. Similarly, it is preferable that the excitation device 31 drives the piezoelectric element 15 in the de-icing mode so as to satisfy V_{dist_heat}>V_{dist_we} compared to the weak vibration mode. V_{dist_we} is the distribution of vibration of the protective cover 11 in the weak vibration mode. The excitation device 31 can reduce or prevent the propagation of heat to the vibration device 10 by controlling the top portion 11a of the protective cover 11 to generate heat before the end portion 11b of the protective cover 11 as described above. The de-icing mode is also called a first distribution mode. The strong vibration mode is also called a second distribution mode. The weak vibration mode is also called a third distribution mode.

Next, the relationship between the sliding angle and adhesion energy will be described.

The sliding angle is the angle between a horizontal plane and a solid surface at which a droplet starts to slide downward when the droplet is attached to a horizontal solid surface and the solid surface is gradually tilted from horizontal. FIG. 6 is a schematic diagram illustrating an example of the relationship between the sliding angle and the adhesion energy. The relationship shown in FIG. 6 can be expressed by the adhesion energy calculation formula (1) proposed by Wolfram.

$$[ Math 1 ]$$

$$E = \frac{mg sin θ}{2 π r} \qquad ( 1 )$$

where E is the adhesion energy, r is a contact radius, m is a droplet mass, g is gravitational acceleration, and θ is the sliding angle. The above formula (1) is a value that is determined experimentally because the sliding angle θ of water and paraffin is proportional to the radius r of the contact surface between the droplet 50 and the solid 51, assuming that the inclination direction component of the gravity of the droplet 50 and the adhesive force acting on the contact circumferential edge are balanced at the sliding angle θ. This index is considered to be an evaluation index that is uniquely determined only by the combination of liquid and solid, and is not influenced by the experimental amount of liquid or angle of inclination.

The above formula (1) shows that the smaller the sliding angle θ, the smaller the adhesion energy E. That is, the smaller the sliding angle θ, the less likely the droplet 50 adheres to the solid surface.

The vibration device 10 vibrates the protective cover 11 at a predetermined vibration acceleration to reduce the sliding angle θ and reduce the adhesion energy E of the droplet trying to stay on the surface of the protective cover 11. The vibration device 10 can thus efficiently remove droplets adhering to the protective cover 11.

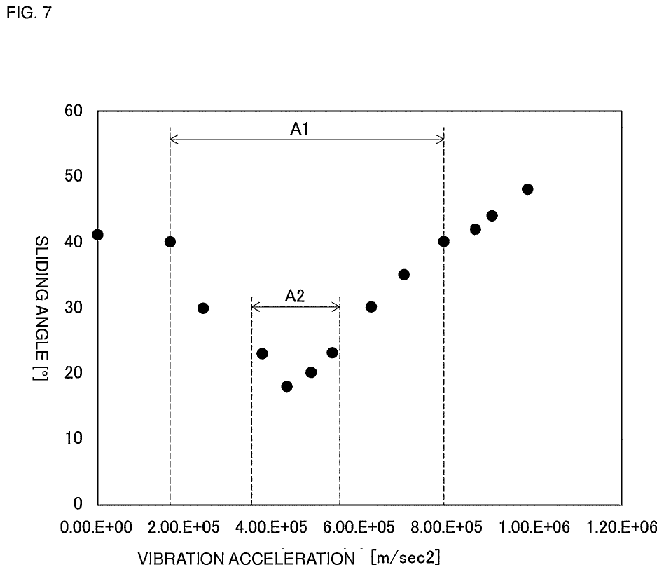

FIG. 7 is a schematic diagram showing an example of the relationship between the sliding angle and vibration acceleration. FIG. 7 shows changes in sliding angle corresponding to changes in vibration acceleration. Note that the vibration acceleration is calculated by the following method.

The vibration acceleration is calculated using a vibration device similar to the vibration device 10. The excitation device 31 sweeps the frequency of the drive signal using a search mode to be described later, and the frequency is checked at which the value of the detection signal detected by the current detection circuit 38 is maximum. As a result, the frequency corresponding to the first removal mode is about 60 kHz. A drive signal is supplied to the piezoelectric element 15 having a resonant frequency of around 60 kHz, using a power supply (Keysight Technologies: E26104A) and a function generator (Tektronix Inc.: AGF1022), to generate vibration. The displacement of the protective cover 11 caused by the vibration of the piezoelectric element 15 is detected using a laser displacement meter (Olympus: BX51M), and measured using a multimeter (Keysight Technologies: 2110) and an oscilloscope (Tektronix Inc.: Oscilloscope TBS1104). The vibration acceleration is calculated using a formula α=(2πf)², where α is the vibration acceleration, f is the frequency, and A is the amplitude (displacement amount).

As shown in FIG. 7, when the vibration acceleration a is 1.5×10⁵ m/s² or more and 8.0×10⁵ m/s² or less, the sliding angle θ is 40 degrees or less (see “A1” in FIG. 7). When the sliding angle θ becomes 40 degrees or less, the adhesion energy E of the droplet becomes smaller than the force of sliding from the surface of the protective cover 11 to the outside. This makes it difficult for the droplet to stay on the protective cover 11, and the droplet flows to the outside of the protective cover 11. This improves the performance of removing foreign matter such as droplets.

When the vibration acceleration α is 3.5×10⁵ m/s² or more and 5.5×10⁵ m/s² or less, the sliding angle θ is 22 degrees or less (see “A2” in FIG. 7). When the sliding angle θ becomes 22 degrees or less, the adhesion energy E of the droplet becomes even smaller. This makes it easier for the droplet to flow to the outside of the protective cover 11, further improving the performance of removing foreign matter such as droplets.

When the vibration acceleration is smaller than 1.5×10⁵ m/s² or larger than 8.0×10⁵ m/s², the sliding angle θ becomes larger than 40 degrees. When the sliding angle θ is larger than 40 degrees, the adhesion energy E of the droplet becomes larger than the force of sliding from the surface of the protective cover 11 to the outside. This makes it more difficult for the droplet to slide compared to when the vibration acceleration α is 3.5×10⁵ m/s² or more and 5.5×10⁵ m/s² or less.

Therefore, there is a preferable range for the vibration acceleration α in the weak vibration mode. In the vibration device according to this example embodiment, the vibration acceleration α in the weak vibration mode is preferably 1.5×10⁵ m/s² or more and 8.0×10⁵ m/s² or less. More preferably, the vibration acceleration α in the weak vibration mode is 3.5×10⁵ m/s² or more and 5.5×10⁵ m/s² or less. The excitation device 31 controls the drive signal so that the vibration acceleration α in the weak vibration mode is within the above range, thus making it possible to improve the sliding property of the droplet adhering to the surface of the protective cover 11 compared to the case where the vibration acceleration α is within another range.

Next, description is given of the strong vibration mode in which the vibration acceleration of the protective cover 11 is larger than that in the weak vibration mode described above.

When the excitation device 31 vibrates the piezoelectric element 15 in the strong vibration mode, the protective cover 11 vibrates with a larger vibration acceleration than when the piezoelectric element 15 is vibrated in the weak vibration mode. The foreign matter such as water droplets adhering to the protective cover 11 is thus atomized and removed. For the vibration acceleration in the strong vibration mode, a value larger than that in the weak vibration mode may be used. However, if the value is too large, load applied to the vibration device 10 itself increases. Therefore, in the vibration device 10 according to this example embodiment, the vibration acceleration α in the strong vibration mode is preferably 8.1×10⁵ m/s² or more and 1.7×10⁶ m/s² or less.

As described above, the excitation device 31 according to this example embodiment can vibrate the protective cover 11 with the first vibration acceleration in the strong vibration mode, and can vibrate the protective cover 11 with the second vibration acceleration smaller than the first vibration acceleration in the weak vibration mode. As described above, the first vibration acceleration is, for example, 8.1×10⁵ m/s² or more and 1.7×10⁶ m/s² or less. The second vibration acceleration is, for example, 1.5×10⁵ m/s² or more and 8.0×10⁵ m/s² or less. The second vibration acceleration may be 3.5×10⁵ m/s² or more and 5.5×10⁵ m/s² or less.

As shown in FIG. 5, when a voltage with a frequency corresponding to the resonant frequency is applied, the impedance of the piezoelectric element 15 becomes locally minimum. Therefore, the control circuit 32 can determine whether the frequency of the voltage applied to the piezoelectric element 15 is the resonant frequency by detecting the value of the current flowing through the piezoelectric element 15.

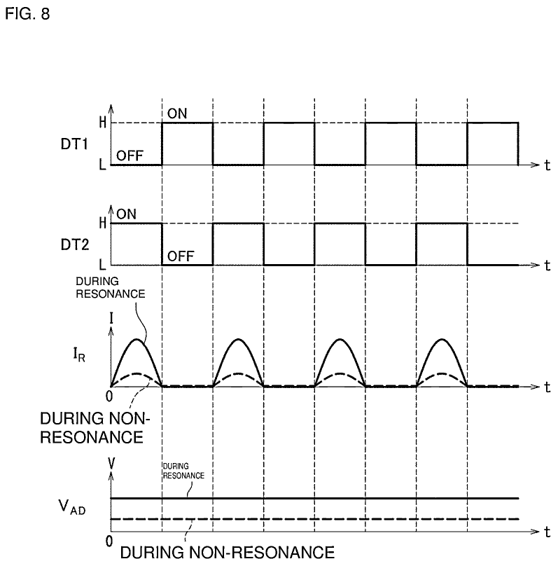

FIG. 8 is a timing chart showing signals inputted to each element of the excitation circuit 31A or signals outputted from each element (for example, a current value and a voltage value). The horizontal axis in FIG. 8 represents time. FIG. 8 shows a signal DT1, a signal DT2, a current I_{R}, and an input voltage V_{AD}. The signal DT1 is an example of a signal for the control circuit 32 to control on and off of the first switch 35. The signal DT2 is an example of a signal for the control circuit 32 to control on and off of the second switch 36. The first switch 35 and the second switch 36 are turned on when the signal DT1 and the signal DT2 are at high level (that is, the first switch 35 electrically connects the DC power supply 33 and the piezoelectric element 15, and the second switch 36 electrically connects the piezoelectric element 15 and the reference potential 34). The first switch 35 and the second switch 36 are turned off when the signal DT1 and the signal DT2 are at low level (that is, the first switch 35 electrically opens the DC power supply 33 and the piezoelectric element 15, and the second switch 36 electrically opens the piezoelectric element 15 and the reference potential 34). The current I_{R} represents a current flowing through the current-voltage conversion element 45. The current I_{R} corresponds to a voltage inputted to the low pass filter 43 based on the current-voltage conversion circuit 42A. The input voltage V_{AD} represents a smoothed voltage inputted from the low pass filter 43 to the AD conversion circuit 44. As shown in FIG. 8, V_{AD} is a signal having a DC component in this example embodiment.

FIG. 8 shows a plurality of waveforms of the current I_{R}. The current I_{R} indicated by the solid line is an example of the waveform of the current flowing through the current-voltage conversion element 45 when the switching frequency of the first switch 35 and the second switch 36 corresponds to the resonant frequency of the vibrator 17 (that is, during resonance). The current I_{R} indicated by the dashed line is an example of the waveform of the current flowing through the current-voltage conversion element 45 when the switching frequency of the first switch 35 and the second switch 36 does not correspond to the resonant frequency of the vibrator 17 (that is, during non-resonance). As is clear from FIG. 8, the current during resonance is larger than the current during non-resonance.

Similarly, FIG. 8 shows a plurality of waveforms of the input voltage V_{AD}. The input voltage V_{AD} indicated by the solid line is an example of the waveform of the voltage that is outputted from the low pass filter 43 and inputted to the AD conversion circuit 44 during resonance. The input voltage V_{AD} indicated by the dashed line is an example of the waveform of the voltage that is outputted from the low pass filter 43 and inputted to the AD conversion circuit 44 during non-resonance. As is clear from FIG. 8, the input voltage during resonance is larger than the input voltage during non-resonance.

Therefore, the signal (voltage) inputted to the AD conversion circuit 44 has a larger value during resonance than during non-resonance. Therefore, the detection signal inputted from the AD conversion circuit 44 to the control circuit 32 similarly has a larger value during resonance than during non-resonance. Therefore, the control circuit 32 can determine whether the switching frequency of the first switch 35 and the second switch 36, that is, the frequency of the drive signal inputted to the piezoelectric element 15 is the resonant frequency, based on the detection signal inputted from the AD conversion circuit 44. For example, the control circuit 32 acquires the value of the detection signal inputted from the AD conversion circuit 44 at two or more switching frequencies when the switches 35 and 36 are each operated at a specific switching frequency. The control circuit 32 can then compare the values of the detection signals at different switching frequencies and determine that the switching frequency corresponding to the detection signal with the larger value is closer to the resonant frequency. Therefore, the control circuit 32 switches each of the switches 35 and 36 at a plurality of switching frequencies within a predetermined frequency range, and compares the values of a plurality of detection signals corresponding to the plurality of switching frequencies. The control circuit 32 can thus determine the switching frequency closest to the resonant frequency within the predetermined frequency range.

Although periods of the signal DT1 and the signal DT2 are different between resonance and non-resonance, FIG. 8 shows, for simplicity, the signal waveforms with the same width even if the periods are different. Therefore, the period during which the current I_{R} flows actually differs between resonance and non-resonance.

The control circuit 32 can thus acquire the current flowing through the current-voltage conversion element 45 of the current-voltage conversion circuit 42A as a DC component based on the switching processing. Therefore, unlike the case of detecting the current flowing through the piezoelectric element 15, the control circuit 32 does not need to set the sampling frequency for current detection sufficiently higher than the resonant frequency of the vibrator 17. This can reduce the cost for the current-voltage conversion circuit 42A. By detecting the current, the control circuit 32 can calculate the impedance of the piezoelectric element 15 and can determine the resonant frequency of the vibrator 17.

As described above, the control circuit 32 can determine the resonant frequency of the vibrator 17 based on the value of the detection signal inputted from the current detection circuit 38A by controlling the switching frequency and changing the frequency of the voltage applied to the piezoelectric element 15. For example, the control circuit 32 can determine the resonant frequency of the vibrator 17 using more than one method. The excitation circuit 31A according to this example embodiment preferably includes three sweep methods: a first sweep method, a second sweep method, and a third sweep method (to be described in detail later). The first sweep method, the second sweep method, and the third sweep method differ in how to change the switching frequency to determine the resonant frequency of the vibrator 17. The control circuit 32 performs a plurality of sequences in each of the first to third sweep methods. In this example embodiment, the plurality of sequences include a search mode and a drive mode.

In the search mode, the control circuit 32 determines the resonant frequency by changing the switching frequency within a predetermined frequency range (hereinafter referred to as a “search frequency range”). Hereinafter, the process in which the control circuit 32 changes the switching frequency by a predetermined increment (or decrement) within an arbitrary frequency range in order to determine the resonant frequency is also referred to as “sweep”. As described above, the control circuit 32 can determine the switching frequency at which the detection signal outputted from the AD conversion circuit 44 has the largest value to be the resonant frequency. Therefore, if the resonant frequency is within the search frequency range, the control circuit 32 can determine the resonant frequency. When the detection signal outputted from the AD conversion circuit 44 has the largest value at the upper limit frequency within the search frequency range, there is a possibility that the switching frequency is not the resonant frequency. Therefore, in such a case, the control circuit 32 may change the search frequency range to include a higher frequency, change the switching frequency within the range, and determine the resonant frequency again. Similarly, when the detection signal outputted from the AD conversion circuit 44 has the largest value at the lower limit frequency within the search frequency range, the control circuit 32 may change the search frequency range to include a lower frequency and determine the resonant frequency again. When determining that there are a plurality of switching frequencies at which the value of the outputted detection signal becomes locally the largest, the control circuit 32 may perform the sweep again.

When determining the resonant frequency by the search mode, the control circuit 32 can perform switching at the frequency to vibrate the protective cover 11 in a predetermined vibration mode (for example, the first removal mode, the second removal mode, or the de-icing mode) corresponding to the frequency. However, the resonant frequency may vary due to various factors. For example, the resonant frequency may vary depending on the temperature change of the protective cover 11. The resonant frequency may also change when foreign matter adheres to the protective cover 11. Therefore, the excitation circuit 31A according to this example embodiment is configured to respond to changes in the frequency in the drive mode.

In the drive mode, the control circuit 32 changes the switching frequency within a predetermined frequency range (hereinafter referred to as a “drive frequency range”) narrower than the search frequency range and determines the resonant frequency. When shifting from the search mode to the drive mode, the control circuit 32 sets the drive frequency range centered on the resonant frequency determined in the search mode, and changes the switching frequency within the drive frequency range. The control circuit 32 sweeps the switching frequency within the drive frequency range, determines the switching frequency with the largest value of the detection signal outputted from the AD conversion circuit 44, and determines that the determined switching frequency is the current resonant frequency of the vibrator 17. After determining the current resonant frequency of the vibrator 17, the control circuit 32 updates the drive frequency range by changing the frequency set at the center of the drive frequency range to the current resonant frequency. The control circuit 32 sweeps the switching frequency again within the updated drive frequency range and repeats the update of the drive frequency range described above. By operating in such a drive mode, the control circuit 32 can make the switching frequency follow the resonant frequency even if the resonant frequency of the vibrator 17 changes.

When the piezoelectric element 15 is vibrated, there is a case where the resonant frequency of the vibrator 17 does not match when changing from the low frequency side to the high frequency side and when changing from the high frequency side to the low frequency side. Therefore, the control circuit 32 of the excitation circuit 31A according to this example embodiment is configured to sweep the switching frequency using a plurality of methods when determining the resonant frequency using the search mode or drive mode. In this example embodiment, as described above, the control circuit 32 has the first sweep method, the second sweep method, and the third sweep method. In the first sweep method, the control circuit 32 changes the switching frequency from the low frequency side to the high frequency side (hereinafter also referred to as “upward sweep”). In the second sweep method, the control circuit 32 changes the switching frequency from the low frequency side to the high frequency side and further from the high frequency side to the low frequency side (hereinafter also referred to as “upward and downward sweep”). In the third sweep method, the control circuit 32 changes the switching frequency from the high frequency side to the low frequency side (hereinafter also referred to as “downward sweep”).

The excitation circuit 31A according to this example embodiment is configured to operate the protective cover 11 in a predetermined vibration mode by matching the switching frequency of the first switch 35 and the second switch 36 with the resonant frequency of the vibrator 17. Even when the first switch 35 and the second switch 36 are operated at a switching frequency that has a predetermined ratio to the resonant frequency, the impedance is locally minimized. Here, the frequency having a predetermined ratio is a frequency that is about 1/(2n+1) times the resonant frequency (n is a positive integer).

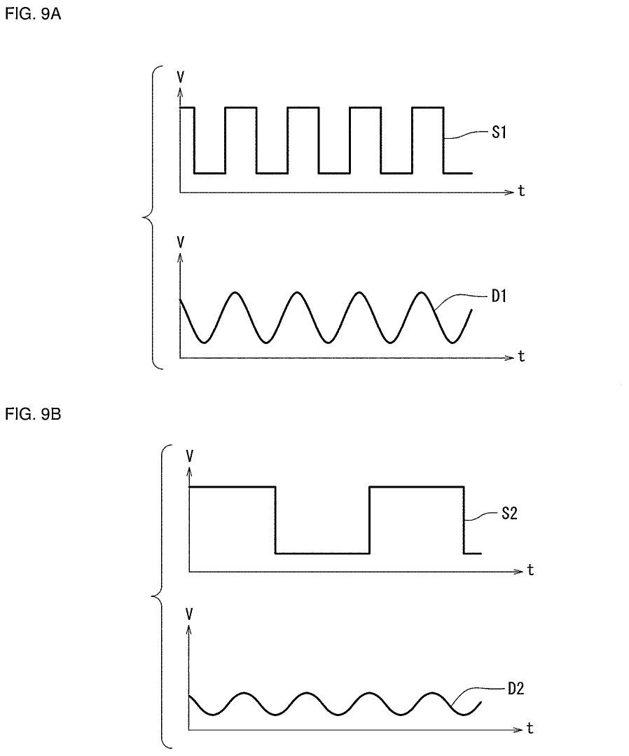

FIG. 9A is a graph showing a temporal change in a drive signal (voltage) having a frequency of 31.5 kHz, which is a frequency near one of the resonant frequencies, applied to the piezoelectric element 15, and a temporal change in displacement amount of the protective cover 11 when the piezoelectric element 15 is driven at that frequency. In FIG. 9A, a waveform S1 indicates the temporal change in the drive signal, and a waveform D1 indicates the temporal change in the displacement amount. The displacement amount of the protective cover 11 can be obtained by measuring the displacement of the protective cover 11 using a laser Doppler meter, for example, and the waveform D1 in FIG. 9A indicates a temporal change in a voltage value obtained by converting the measured displacement amount into voltage. In the graph shown in FIG. 9A, the horizontal axis represents time and the vertical axis represents voltage.

FIG. 9B is a graph showing a temporal change in a drive signal having a frequency of 10.5 kHz, which is about ⅓ times the frequency of 31.5 kHz, applied to the piezoelectric element 15, and a temporal change in displacement amount of the protective cover 11 when the piezoelectric element 15 is driven at that frequency. In FIG. 9B, a waveform S2 indicates the temporal change in the drive signal, and a waveform D2 indicates the temporal change in the displacement amount. In the graph shown in FIG. 9B, the horizontal axis represents time and the vertical axis represents voltage.

As can be seen from FIGS. 9A and 9B, even when the frequency of the drive signal is about ⅓ times the resonant frequency, the frequency of displacement of the protective cover 11 (that is, the frequency of vibration of the protective cover 11) is equal to the resonant frequency. As can be seen from FIGS. 9A and 9B, the maximum displacement amount when the piezoelectric element 15 is driven at a frequency that is about ⅓ times the resonant frequency is about ⅓ times the maximum displacement amount when the piezoelectric element 15 is driven at the resonant frequency. The above relationship is satisfied when the frequency of the drive signal is about 1/(2n+1) times the resonant frequency (n is a positive integer). In other words, when the frequency of the drive signal is about 1/(2n+1) times the resonant frequency, the maximum displacement amount of the protective cover 11 is about 1/(2n+1) times the maximum displacement amount when the piezoelectric element 15 is driven at the resonant frequency. By utilizing such changes in the displacement amount based on the difference in the frequency of the drive signal, the vibration device 10 according to this example embodiment can obtain various effects.

For example, description is given of a case where, when the excitation device 31 applies a drive signal having a voltage of 60 Vp-p and a frequency of 60 kHz to the piezoelectric element 15, the vibration acceleration of the protective cover 11 becomes 1.5×10⁶ m/s². In the case of the vibration device, when the excitation device 31 applies a drive signal having a voltage of 60 Vp-p and a frequency of 20 kHz to the piezoelectric element 15, the protective cover 11 vibrates with a vibration acceleration of 0.5×10⁶ m/s². The excitation device 31 can thus change the vibration acceleration of the vibration of the protective cover 11 without changing the voltage by controlling the frequency of the drive signal applied to the piezoelectric element. This makes it possible for excitation device 31 to control the amplitude of vibration of the protective cover 11 without having a complicated configuration or executing complicated control.

For example, in the search mode, the control circuit 32 can determine the frequency corresponding to the resonant frequency by sweeping the switching frequency in a search frequency range that includes a frequency equivalent to about ⅓ times the resonant frequency. The control circuit 32 determines a frequency three times the switching frequency determined to correspond to the resonant frequency as the resonant frequency, defines a drive frequency range centered around the frequency of about three times the switching frequency, and executes the drive mode. The control circuit 32 can thus reduce the power consumption necessary for the determination while reducing or preventing the temperature increase of the piezoelectric element 15. The control circuit 32 can also reduce or prevent vibrations that occur when executing the search mode by lowering the current value, and can reduce or prevent fluctuations in the resonant frequency due to changes in the state of foreign matter or the like due to the vibrations.

The above relationship also is satisfied between the resonant frequency and a frequency 2n+1 times the resonant frequency (n is a positive integer). For example, when the control circuit 32 applies a drive signal having a frequency of about three times the resonant frequency to the piezoelectric element 15, the temporal change in the displacement amount of the protective cover 11 has a frequency corresponding to the resonant frequency, as in the case of FIG. 9A. The maximum value of the displacement amount of the protective cover 11 is about ⅓ times the maximum value of the displacement amount when a drive signal having the resonant frequency is applied. Therefore, in order to reduce or prevent the temperature rise of the piezoelectric element 15, the control circuit 32 may operate by setting the switching frequency to switch on and off of the first switch 35 and the second switch 36 to about (2n+1) times the resonant frequency.

The control circuit 32 determines whether foreign matter adheres to the protective cover 11 by combining changes in the resonant frequency and changes in impedance. The resonant frequency of the vibrator 17 decreases as the temperature increases. Similarly, the minimum impedance (local minimum value of impedance) of the piezoelectric element 15 decreases as the temperature increases. On the other hand, when foreign matter (for example, water) adheres to the protective cover 11, the resonant frequency of the vibrator 17 decreases as the amount of adhering water increases. The rate of change in the minimum impedance of the piezoelectric element 15 increases as the amount of adhering water increases. The control circuit 32 can thus determine whether foreign matter adheres to the protective cover 11 by referring to the change in temperature and the change in minimum impedance. Note that the change in temperature may be acquired by a temperature sensor that may be provided in the vibration device 10, for example. The control circuit 32 may drive the piezoelectric element 15 at a frequency of about 1/(2n+1) times the resonant frequency (n is a positive integer) in the search mode as described above until the foreign matter adheres. Once it is determined that there is foreign matter adhering to the protective cover, the control circuit 32 may drive the piezoelectric element 15 at the resonant frequency by switching to the drive mode. The control circuit 32 can reduce the power consumption of the vibration device 10 by driving the piezoelectric element 15 as described above.

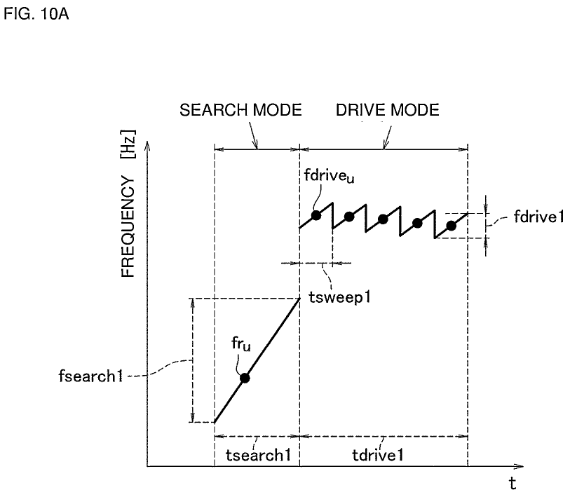

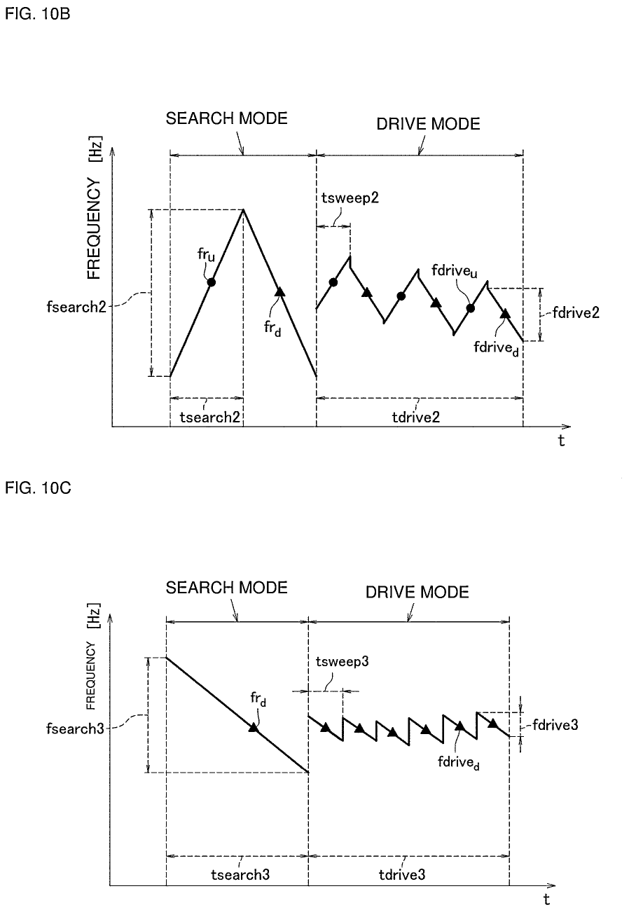

FIG. 10A shows an example of control by the first sweep method for the control circuit 32 to determine the resonant frequency. FIG. 10B shows an example of control by the second sweep method for the control circuit 32 to determine the resonant frequency. FIG. 10C shows an example of control by the third sweep method for the control circuit 32 to determine the resonant frequency.

FIG. 10A shows an example of search mode and drive mode processing by the control circuit 32 using the first sweep method. In this example embodiment, the control circuit 32 sets the search frequency range to include a frequency of about ⅓ times the resonant frequency, and executes the search mode. In FIG. 10A, fsearch1 denotes the search frequency range. The control circuit 32 sweeps upward the switching frequency to determine a frequency frᵤ at which the current reaches its maximum within the search frequency range, and then multiplies the value of the frequency frᵤ by three to obtain fdriveᵤ. As shown in FIG. 10A, the control circuit 32 executes the sweep in a period tsearch1.

The control circuit 32 sets the drive frequency range so that the calculated fdriveᵤ is centered, and executes the drive mode. In FIG. 10A, fdrive1 denotes the drive frequency range. The control circuit 32 sweeps upward the switching frequency within the drive frequency range, determines the frequency at which the current value reaches its maximum, and updates fdriveᵤ to the frequency. As shown in FIG. 10A, the control circuit 32 executes the sweep in the drive frequency range in a period tsweep1. Then, the control circuit 32 updates the drive frequency range every time it executes the sweep, and again executes the sweep in the updated drive frequency range in the period tsweep1. The period tdrive1 indicates a period in which the piezoelectric element 15 is driven in the drive mode. By operating as described above, the control circuit 32 can vibrate the protective cover 11 at a more accurate frequency while following the changing resonant frequency. After driving the piezoelectric element 15 in the drive mode for a predetermined period, such as the period tdrive1, for example, the control circuit 32 may switch to driving the piezoelectric element 15 in the search mode again. The control circuit 32 may also switch from driving in the drive mode to driving in the search mode when determining that the adhesion of foreign matter is eliminated based on a change in temperature and a change in impedance, for example. The control circuit 32 may stop driving the piezoelectric element, instead of switching from the drive mode to the search mode. The same applies to the second sweep method and the third sweep method to be described later.

FIG. 10B shows an example of search mode and drive mode processing by the control circuit 32 using the second sweep method. In this example embodiment, the control circuit 32 sets the search frequency range to include the frequency corresponding to the resonant frequency, and executes the search mode. In FIG. 10B, fsearch2 denotes the search frequency range. The control circuit 32 sweeps upward the switching frequency to determine a frequency frᵤ at which the current reaches its maximum within the search frequency range, and then determines fdriveᵤ based on the frequency frᵤ. The control circuit 32 sets an upward drive frequency range to be centered around the determined fdriveᵤ. The control circuit 32 also sweeps downward the switching frequency to determine a frequency fr_{d} at which the current reaches its maximum within the search frequency range, and then determines fdrive_{d} based on the frequency fr_{d}. The control circuit 32 sets a downward drive frequency range to be centered around the determined fdrive_{d}. As shown in FIG. 10B, the control circuit 32 executes an upward sweep and a downward sweep in a period tsearch2. Note that the period tsearch2 for the upward sweep and the period tsearch2 for the downward sweep may have the same length or different lengths.

Once the upward and downward drive frequency ranges are set, the control circuit 32 executes the drive mode. The control circuit 32 sweeps the switching frequency upward and downward within each drive frequency range to determine the frequency at which the current value reaches its maximum, and updates fdriveᵤ and fdrive_{d} to each frequency. As shown in FIG. 10B, the control circuit 32 executes the upward sweep and downward sweep within the drive frequency range in a period tsweep2. Then, the control circuit 32 updates each drive frequency range every time it executes the upward sweep or downward sweep, and again executes a sweep within the updated drive frequency range in the period tsweep2. A period tdrive2 indicates a period during which the piezoelectric element 15 is driven in the drive mode. By operating as described above, the control circuit 32 can vibrate the protective cover 11 at a more accurate frequency while following the changing resonant frequency for each of the upward sweep and the downward sweep.

FIG. 10C shows an example of search mode and drive mode processing by the control circuit 32 using the third sweep method. In this example embodiment, the control circuit 32 sets the search frequency range to include the frequency corresponding to the resonant frequency, and executes the search mode. In FIG. 10C, fsearch3 denotes the search frequency range. The control circuit 32 sweeps downward the switching frequency to determine a frequency fr_{d} at which the current reaches its maximum within the search frequency range, and then determines fdrive_{d} based on the frequency fr_{d}. As shown in FIG. 10C, the control circuit 32 executes a sweep in a period tsearch3.

The control circuit 32 sets the drive frequency range to be centered around the determined fdrive_{d}, and executes the drive mode. In FIG. 10C, fdrive3 denotes the drive frequency range. The control circuit 32 sweeps downward the switching frequency downward within the drive frequency range to determine a frequency at which the current value reaches its maximum, and updates fdrive_{d} to the frequency. As shown in FIG. 10C, the control circuit 32 executes a sweep within the drive frequency range in a period tsweep3. Then, the control circuit 32 updates the drive frequency range every time it executes the sweep, and again executes the sweep within the updated drive frequency range in the period tsweep3. A period tdrive3 indicates a period during which the piezoelectric element 15 is driven in the drive mode. By operating as described above, the control circuit 32 can vibrate the protective cover 11 at a more accurate frequency while following the changing resonant frequency.

For example, the control circuit 32 can use the first sweep method described above in the first removal mode. The control circuit 32 can also use the second sweep method described above in the second removal mode. The control circuit 32 can also use the third sweep method described above in the de-icing mode. The sweep method used in each vibration mode is not limited to the above, and the control circuit 32 may vibrate the piezoelectric element 15 in any combination. In the first sweep method described above, the control circuit 32 drives the piezoelectric element 15 using a frequency that is about ⅓ of the resonant frequency in the search mode, and drives the piezoelectric element 15 using the resonant frequency in the drive mode. However, the present disclosure is not limited thereto. In the second sweep method and the third sweep method described above, the control circuit 32 drives the piezoelectric element 15 using the resonant frequency in the search mode and drive mode, but the present disclosure is not limited thereto. For example, the control circuit 32 may use at least one of the first to third sweep methods to drive the piezoelectric element 15 using the resonant frequency in the search mode and the drive mode. The control circuit 32 may also use at least one of the first to third sweep methods to drive the piezoelectric element 15 using a frequency of about 1/(2n+1) times the resonant frequency in the search mode and drive the piezoelectric element 15 using the resonant frequency in the drive mode. The control circuit 32 may also use at least one of the first to third sweep methods to drive the piezoelectric element 15 using the resonant frequency in the search mode and drive the piezoelectric element 15 using a frequency of about 1/(2n+1) times the resonant frequency in the drive mode. The control circuit 32 may also use at least one of the first to third sweep methods to drive the piezoelectric element 15 using a frequency of about 1/(2n+1) times the resonant frequency in the search mode and the drive mode.

As described above, the control circuit 32 can drive the piezoelectric element 15 in a plurality of vibration modes using the search mode and the drive mode. The control circuit 32 may change at least one of the search frequency range and the drive frequency range depending on the vibration mode. For example, the control circuit 32 may control the drive frequency range in the de-icing mode to be different from the drive frequency range in the strong vibration mode. Hereinafter, the drive frequency range in the de-icing mode is also referred to as a first frequency range. The vibration mode in which the drive mode is executed in the first frequency range is also referred to as a first sweep mode. The drive frequency range in the strong vibration mode is also referred to as a second frequency range. The vibration mode in which the drive mode is executed in the second frequency range is also referred to as a second sweep mode.

Specifically, when the de-icing mode is executed by the third sweep method and the strong vibration mode is executed by the first sweep method, for example, the control circuit 32 may control the first frequency range and the second frequency range to satisfy (HW1/SR1)>(HW2/SR2). Here, HW1 is a half-value width of a peak at the resonant frequency in the displacement of the protective cover 11 when the sweep is executed within the first frequency range. SR1 is the width of the first frequency range. HW2 is a half-value width of a peak at the resonant frequency in the displacement of the protective cover 11 when the sweep is executed within the second frequency range. Specifically, HW2 is the half-value width of the peak at the resonant frequency within the second frequency range. SR2 is the width of the second frequency range.

For example, when the resonant frequency is 500 kHz in the de-icing mode, the control circuit 32 can control the resonant frequency to sweep within a range of ±1 kHz. In this case, as an example, HW1=1000 and SR1=2000. When the resonant frequency is 25 kHz in the strong vibration mode, the control circuit 32 can control the resonant frequency to sweep within a range of ±0.5 kHz. In this case, as an example, HW2=100 and SR2=1000. When the control circuit 32 controls the first frequency range and the second frequency range as described above, (HW1/SR1)>(HW2/SR2) is satisfied.

The relationship between HW1 and SR1 and between HW2 and SR2 described above is not limited, as a matter of course, to the case where the third sweep method is executed in the de-icing mode and the first sweep method is executed in the strong vibration mode. The control circuit 32 may control the frequency range depending on the relationship between HW1 and SR1 and between HW2 and SR2 when executing the de-icing mode and the strong vibration mode using other sweep methods. Such control allows the excitation device 31 to take into consideration the sharpness of the resonance (so-called Q value) to increase the ratio of time spent driving the piezoelectric element at the frequency based on the resonant frequency to the time spent sweeping the frequency in the de-icing mode, compared to the strong vibration mode. Therefore, the excitation device 31 can improve its contribution to the temperature rise of the protective cover 11 when the de-icing mode is executed in the drive mode, compared to the case of the strong vibration mode. The excitation device 31 can thus raise the temperature of the protective cover 11 more quickly.

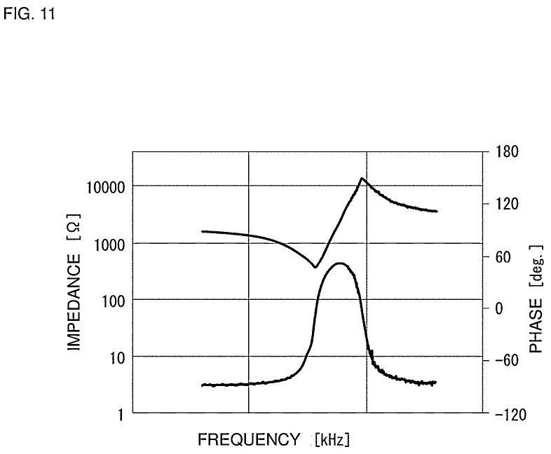

FIG. 11 is a graph showing the impedance of the piezoelectric element 15 with respect to the switching frequency near a certain resonant frequency and a phase difference between the voltage applied to the piezoelectric element 15 and the current flowing through the piezoelectric element 15. As shown in FIG. 11, when the switching frequency changes around the resonant frequency, the impedance changes. As described above, the frequency at which the impedance is locally minimized corresponds to the resonant frequency. As shown in FIG. 11, when the switching frequency changes near the resonant frequency, the phase difference between the voltage applied to the piezoelectric element 15 and the current flowing through the piezoelectric element changes. When the control circuit 32 switches the first switch 35 and the second switch 36 at the resonant frequency, the phase difference becomes zero. Therefore, by configuring the excitation circuit 31A to detect this phase difference, the switching frequency corresponding to the resonant frequency can be determined more accurately.

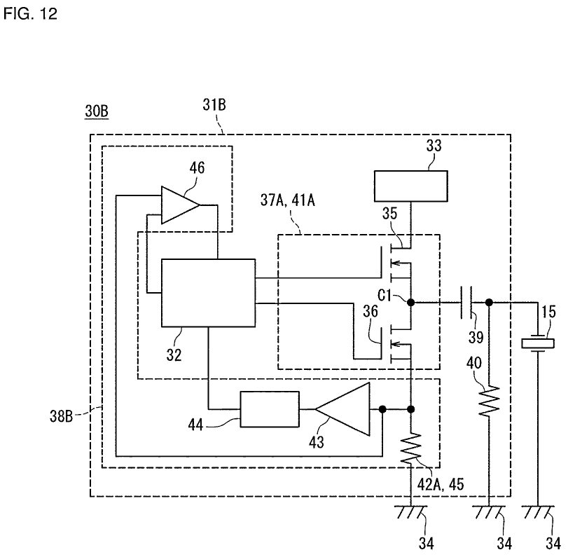

FIG. 12 shows a modification of the excitation circuit 31A according to this example embodiment. FIG. 12 shows a vibration circuit 30B. The vibration circuit 30B includes an excitation circuit 31B and a piezoelectric element 15. The excitation circuit 31B further includes a phase comparator 46, compared to the excitation circuit 31A. The excitation circuit 31B is configured such that the phase comparator 46 can compare the phase difference between the voltage applied to the piezoelectric element 15 and the current flowing through the piezoelectric element, as described above.

The phase comparator 46 is a multiplier, for example. The phase comparator 46 can detect a voltage based on the current flowing through the current-voltage conversion element 45. The phase related to the current used by the phase comparator 46 is the current flowing through the current-voltage conversion element 45 when the second switch 36 is on. The control circuit 32 can also output a control signal to switch the first switch 35 and the second switch 36 to the phase comparator 46. Therefore, the phase comparator 46 can compare the phase of the voltage applied to the piezoelectric element 15 and the phase of the current flowing through the piezoelectric element, based on the phase of the control signal. For example, the phase comparator 46 may be configured to compare the phase of the control signal to drive the second switch 36 with the phase of the voltage based on the current flowing through the current-voltage conversion element 45, and to output a predetermined signal (for example, voltage) to the control circuit 32 when there is a difference in phase. The phase comparator 46 may output a voltage having a positive value when the phase of the control signal is ahead of the phase of the voltage based on the current flowing through the current-voltage conversion element 45, and may output a voltage having a negative value when the phase is delayed to the control circuit 32. With this configuration, the control circuit 32 can detect if there is a phase difference between the current and voltage in the piezoelectric element 15, based on the signal outputted from the phase comparator 46. The control circuit 32 can also detect whether the phase of the current is ahead of or behind the voltage. As can be seen from FIG. 12, when the switching frequency is near the resonant frequency, advance or delay of the phase between the voltage applied to the piezoelectric element 15 and the current flowing through the piezoelectric element 15 depends on whether the switching frequency is higher than or lower than the resonant frequency. Therefore, the control circuit 32 can determine based on the phase difference whether the switching frequency needs to be changed to the high frequency side or the low frequency side, in order to match the switching frequency with the resonant frequency. The control circuit 32 can more appropriately match the switching frequency with the resonant frequency of the vibrator 17 by controlling the switching frequency based on the phase difference detected by the phase comparator 46. Contrary to the above, the phase comparator 46 may output a voltage having a negative value when the phase of the control signal is ahead of the phase of the voltage based on the current flowing through the current-voltage conversion element 45, and may when it is delayed, and may output a voltage having a positive value when the phase is delayed to the control circuit 32.

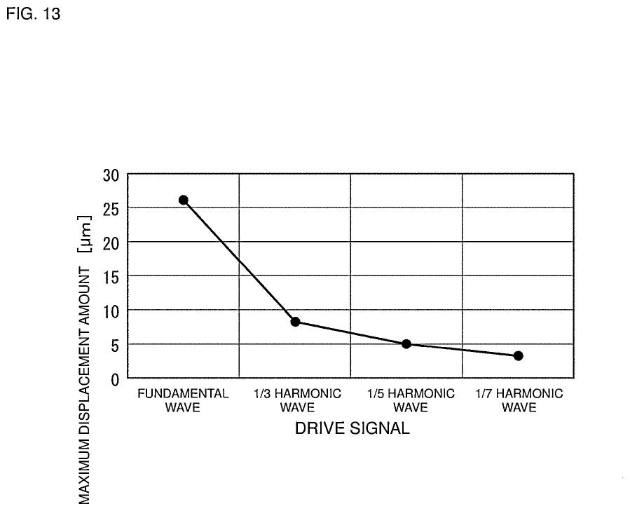

FIG. 13 shows the displacement of the protective cover 11 vibrated by the piezoelectric element 15 when the piezoelectric element 15 is driven by a drive signal having the resonant frequency in the strong vibration mode and by a drive signal having a frequency of about 1/(2n+1) times the resonant frequency. In the graph shown in FIG. 13, the horizontal axis represents the frequency of the drive signal, and the vertical axis represents the maximum displacement amount (μm) of the protective cover 11 for each drive signal. In FIG. 13, the drive signal having the resonant frequency is shown as a fundamental wave. The drive signals having frequencies ⅓ times (n=1), ⅕ times (n=2), and 1/7 times (n=3) the resonant frequency are shown as a ⅓ harmonic wave, a ⅕ harmonic wave, and a 1/7 harmonic wave. Hereinafter, the drive signal having the resonant frequency is also referred to as the fundamental wave. The drive signal having a frequency that is about 1/(2n+1) times the resonant frequency is also referred to as an approximately 1/(2n+1) harmonic wave. The drive signal having a frequency that is about (2n+1) times the resonant frequency is also referred to as an approximately (2n+1) harmonic wave. As is clear from FIG. 13, when the excitation device 31 drives the piezoelectric element 15 with a drive signal having the approximately ⅓ harmonic wave, the maximum displacement amount of the protective cover 11 vibrated by the piezoelectric element 15 is about ⅓ times the maximum displacement amount when the piezoelectric element is driven by the drive signal having the resonance frequency. Specifically, in the example shown in FIG. 13, when the excitation device 31 drives the piezoelectric element 15 with the drive signal having the fundamental wave, the maximum displacement amount of the protective cover 11 is about 26 μm. When the excitation device 31 drives the piezoelectric element 15 with the drive signal having the ⅓ harmonic wave, the maximum displacement amount of the protective cover 11 is about 8 μm. Similarly, when the excitation device 31 drives the piezoelectric element 15 with a drive signal having the ⅕ harmonic wave or 1/7 harmonic wave, the maximum displacement amount of the protective cover 11 is about ⅕ times or about 1/7 times the maximum displacement amount when the piezoelectric element is driven with the drive signal having the resonant frequency. Specifically, when the excitation device 31 drives the piezoelectric element 15 with the drive signals having the ⅕ harmonic wave and the 1/7 harmonic wave, the maximum displacement amount of the protective cover 11 is about 5 μm and about 4 μm, respectively.

The displacement amount of the protective cover 11 can thus be changed by the excitation device 31 controlling the frequency of the drive signal to drive the piezoelectric element 15. When the excitation device 31 determines the resonant frequency by sweeping the frequency of the drive signal as in the search mode described above, execution in the strong vibration mode eliminates the need to execute in the weak vibration mode, and thus the control can be simplified. The excitation device 31 can determine the resonant frequency in the strong vibration mode and the resonant frequency in the weak vibration mode without changing the voltage.

When determining the resonant frequency by sweeping the frequency of the drive signal, the excitation device 31 may execute the sweep using a drive signal having a frequency of about 1/(2n+1) times. Here, n is a positive integer. Then, the excitation device 31 may drive the piezoelectric element 15 with a drive signal having a frequency that is about (2n+1) times the frequency at which the detection signal outputted by the current detection circuit 38 reaches its maximum. Such control can reduce the amount of vibration of the protective cover 11 in the search mode, and thus can reduce the influence of the vibration of the protective cover 11 on the optical characteristics or reliability.

In the above example, the excitation device 31 drives the piezoelectric element 15 at a frequency of about 1/(2n+1) times the resonant frequency to determine the resonant frequency, and further drives the piezoelectric element 15 at the resonant frequency. However, the present disclosure is not limited thereto. For example, the excitation device 31 may drive the piezoelectric element 15 at a frequency that is about 1/(2n_{search}+1) times the resonant frequency to determine the resonant frequency, and may further drive the piezoelectric element 15 at a frequency that is about 1/(2nₐ+1) times the resonant frequency. Here, nₐ is an integer greater than or equal to 0, and n_{search} is an integer greater than nₐ.

In the above example, the excitation device 31 drives the piezoelectric element 15 using the resonant frequency and the drive signal having the frequency 1/(2n+1) times the resonant frequency, but the present disclosure is not limited to this example. For example, when the excitation device 31 drives the piezoelectric element 15 with a drive signal having a frequency that is about (2n+1) times the resonant frequency, the maximum displacement amount of the protective cover 11 is about 1/(2n+1) times the maximum displacement amount when the piezoelectric element is driven with the drive signal having the resonant frequency. Therefore, the excitation device 31 may drive the piezoelectric element 15 using the resonant frequency and the drive signal having the frequency of about (2n+1) times the resonant frequency.

As in the above example, the waveform of the drive signal used by the excitation device 31 to drive the piezoelectric element 15 is preferably a rectangular wave, but is not limited to the rectangular wave. For example, the excitation device 31 may use a sine wave, a triangular wave, or a sawtooth wave having a resonant frequency and a frequency of about 1/(2n+1) times or about (2n+1) times the resonant frequency, as the drive signal.

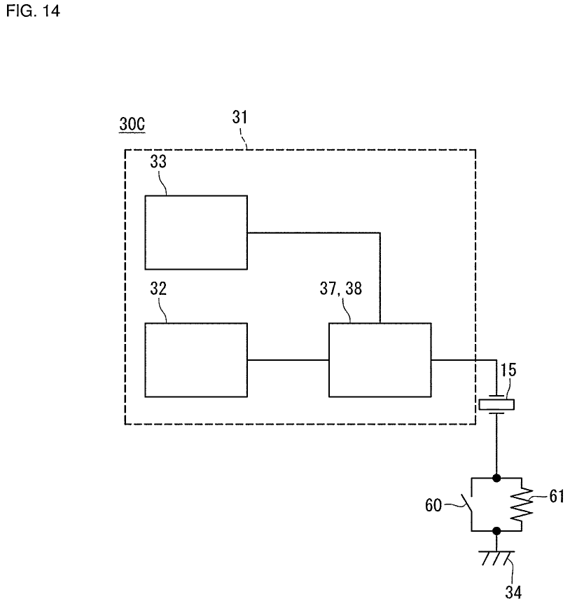

FIG. 14 is a schematic diagram of a modification of the vibration circuit 30 according to this example embodiment. As shown in FIG. 14, the vibration circuit 30C includes, in addition to the excitation device 31 and the piezoelectric element 15, a switch 60 and a resistor 61 disposed in parallel between the piezoelectric element 15 and the reference potential 34.

The switch 60 can be turned on and off by the control circuit 32. As is clear from FIG. 14, when the switch 60 is on, the piezoelectric element 15 is connected to the reference potential 34. When the switch 60 is off, the piezoelectric element 15 is connected to the reference potential 34 through the resistor 61. Therefore, when the switch 60 is off, the impedance when the excitation device 31 drives the piezoelectric element 15 increases, and the displacement amount of the protective cover 11 decreases compared to when the switch 60 is on. Therefore, the excitation device 31 can perform more detailed control of the amplitude of the protective cover 11 by combining the configuration of this modification and the method of driving the piezoelectric element 15 with the drive signal having the frequency of about 1/(2n+1) times the resonant frequency described above.

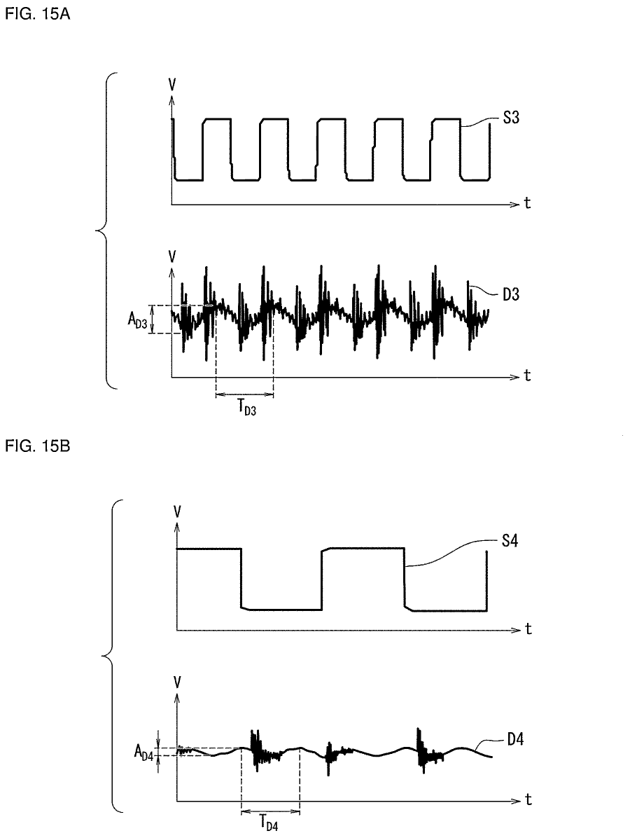

FIG. 15A is a graph showing a temporal change in a drive signal (voltage) having a frequency of about 557 kHz, which is a frequency near one of the resonant frequencies, applied to the piezoelectric element 15, and a temporal change in displacement amount of the protective cover 11 when the piezoelectric element 15 is driven at this frequency. In FIG. 15A, a waveform S3 represents the temporal change in the drive signal, and a waveform D4 represents a temporal change in the displacement amount of the protective cover 11. In the graph shown in FIG. 15A, the horizontal axis represents time and the vertical axis represents voltage.

FIG. 15B shows a temporal change in a drive signal having a frequency of about 190 kHz, which is about ⅓ times the frequency of 557 kHz, applied to the piezoelectric element 15 and a temporal change in the displacement amount of the protective cover 11 when the piezoelectric element 15 is driven at this frequency. In FIG. 15B, a waveform S4 represents the temporal change in the drive signal, and a waveform D4 represents a temporal change in the displacement amount of the protective cover 11. In the graph shown in FIG. 15B, the horizontal axis represents time and the vertical axis represents voltage.

As described above, the excitation device 31 vibrates the piezoelectric element 15 in the de-icing mode using the drive signal having the resonant frequency of about 557 kHz. As can be seen from FIGS. 15A and 15B, the period T_{D4} of the waveform D4 is equivalent to the period T_{D3} of the waveform D3. The amplitude A_{D4} of the waveform D4 is about ⅓ times the amplitude A_{D3} of the waveform D3. In the de-icing mode, when the excitation device 31 drives the piezoelectric element 15 with the drive signal having the frequency that is about ⅓ of the resonant frequency, the protective cover 11 can be vibrated with the displacement amount that is about ⅓ times the displacement amount when driving with the drive signal having the resonant frequency. An example of the power when the excitation device 31 drives the piezoelectric element 15 with a drive signal of about 557 kHz is about 15 W. An example of the power when the excitation device 31 drives the piezoelectric element 15 with a drive signal of about 190 kHz is about 5 W. Therefore, in the de-icing mode, again, the displacement amount of the protective cover 11 can be reduced and the power consumption can be reduced as in the case where the piezoelectric element 15 is vibrated with the drive signal of 31.5 kHz described above. The excitation device 31 can thus reduce the power consumption by driving the piezoelectric element 15 with the drive signal having the frequency of about 1/(2n+1) times the resonant frequency in the de-icing mode. This can eliminate the need for the excitation device 31 to use a member that can withstand a large voltage. Therefore, the user of the excitation device 31 can reduce the cost of the excitation device 31.

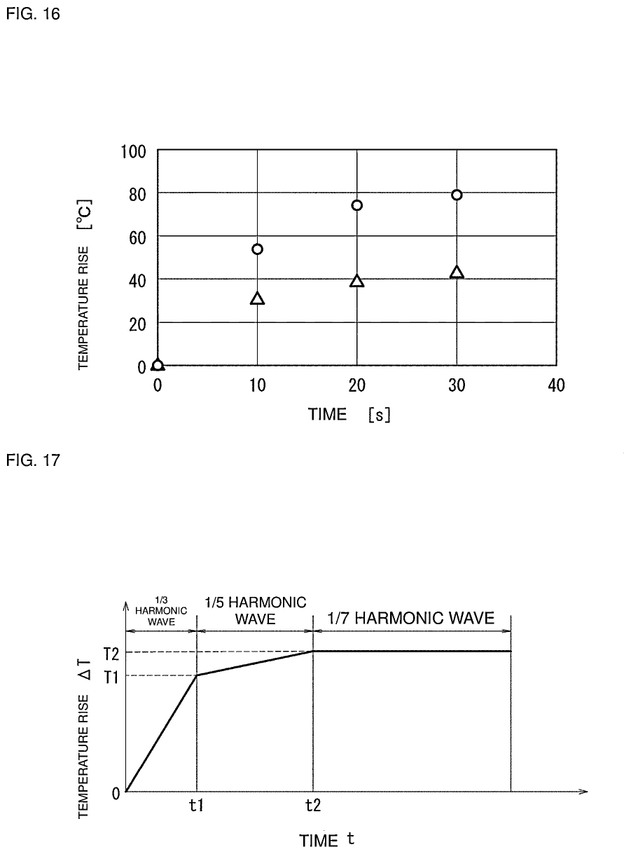

FIG. 16 is a graph showing an example of temperature rise characteristics of the protective cover 11 when the excitation device 31 vibrates the piezoelectric element 15. In the graph shown in FIG. 16, the horizontal axis represents time t(s) and the vertical axis represents temperature rise ΔT (° C.). In FIG. 16, the circles indicate the temperature of the protective cover 11 when the piezoelectric element 15 is driven with a drive signal (that is, fundamental wave) having a resonant frequency around about 550 kHz. The triangles indicate the temperature of the protective cover 11 when the piezoelectric element 15 is driven with a drive signal having a frequency of about ⅓ times the fundamental wave (that is, about ⅓ harmonic wave). As can be seen from FIG. 16, the temperature rise of the protective cover 11 when the piezoelectric element 15 is driven by the approximately ⅓ harmonic wave clearly decreases compared to the temperature rise when the piezoelectric element 15 is driven by the fundamental wave. For example, when the piezoelectric element 15 is driven by the fundamental wave for 20 seconds, the temperature rise of the protective cover 11 is about 75° C. When the piezoelectric element 15 is driven by the approximately ⅓ harmonic wave for 20 seconds, the temperature rise of the protective cover 11 is about 40° C. The excitation device 31 can thus control the temperature rise of the protective cover 11 without changing the voltage of the drive signal by controlling the frequency of the drive signal to drive the piezoelectric element 15.

FIG. 17 is a graph showing an example of a method for controlling the temperature rise of the protective cover 11 by the excitation device 31 in the de-icing mode. In the graph shown in FIG. 17, the horizontal axis represents time t and the vertical axis represents the temperature rise ΔT. When the excitation device 31 executes vibration processing in the de-icing mode, the temperature of the protective cover 11 is basically low (for example, below the ambient temperature). Therefore, it is preferable that the excitation device 31 drives the piezoelectric element 15 so as to quickly raise the temperature of the protective cover 11. It is also preferable that, after the temperature of the protective cover 11 rises, the excitation device 31 drives the piezoelectric element 15 so as to maintain the temperature. The excitation device 31 can control such temperature rise by controlling the frequency of the drive signal to drive the piezoelectric element 15. Specifically, for example, the excitation device 31 first drives the piezoelectric element 15 with a drive signal having a frequency that is about ⅓ times the resonant frequency corresponding to the de-icing mode, and quickly raises the temperature of the protective cover 11. Then, when the raised temperature of the protective cover 11 reaches a predetermined temperature (indicated by Ti in FIG. 17), the excitation device 31 switches the frequency of the drive signal to a frequency that is about ⅕ times the resonant frequency. When the raised temperature of the protective cover 11 reaches a temperature higher than T1 (indicated by T2 in FIG. 17), the excitation device 31 switches the frequency of the drive signal to a frequency that is about 1/7 times the resonant frequency. Such control allows the excitation device 31 to raise the temperature of the protective cover 11 more quickly in the de-icing mode and to prevent the protective cover 11 from excessively rising in temperature. For such control, for example, the vibration device 10 may be provided with a temperature sensor configured to be able to communicate with the excitation device 31. The excitation device 31 may also switch the frequency of the drive signal based on the drive time for vibrating the piezoelectric element 15, instead of the temperature of the protective cover 11. For example, the excitation device 31 first drives the piezoelectric element 15 with a drive signal having a frequency of about ⅓ times the resonant frequency corresponding to the de-icing mode, and quickly raises the temperature of the protective cover 11. Then, when the excitation device 31 drives the piezoelectric element 15 for a certain period of time (indicated by t1 in FIG. 17) with a drive signal having a frequency that is about ⅓ times the resonant frequency, the excitation device 31 may switch the frequency of the drive signal to a frequency that is about ⅕ times the resonant frequency. Similarly, when the excitation device 31 further drives the piezoelectric element 15 for a certain period of time (indicated by t2 in FIG. 17), the excitation device 31 may switch the frequency of the drive signal to a frequency that is about 1/7 times the resonant frequency. As a matter of course, the excitation device 31 may combine the control of switching the frequency of the drive signal based on the temperature of the protective cover 11 described above and the control of switching the frequency of the drive signal based on the drive time.

The excitation device 31 can remove foreign matter adhering to the protective cover 11 by combining the vibration modes described above. For example, when muddy water adheres to the protective cover 11, the excitation device 31 may be controlled to remove mud by driving the piezoelectric element 15 in the de-icing mode to dry the water content of the muddy water, and then driving the piezoelectric element 15 in the strong vibration mode. The excitation device 31 may constantly drive the piezoelectric element 15 in the weak vibration mode that consumes low power and has little influence on the vibration device 10, thereby causing foreign matter adhering to the protective cover 11 to slide off. The excitation device 31 may be controlled to remove dirt that cannot be removed in the weak vibration mode by further using the de-icing mode or the strong vibration mode.

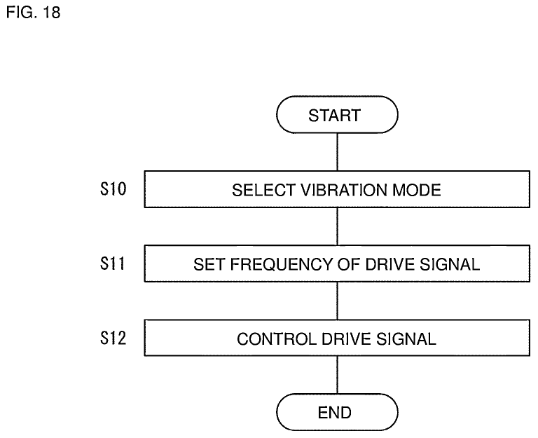

Next, vibration processing of the vibration device 10 by the control circuit 32 will be described based on a flowchart. FIG. 18 is a flowchart for explaining the vibration processing of the vibration device 10 by the control circuit 32 of the excitation device 31 according to this example embodiment.

First, the control circuit 32 selects a predetermined vibration mode from a plurality of vibration modes to apply a drive signal having a frequency based on the resonant frequency of the vibrator 17 to the piezoelectric element (S10). The control circuit 32 can thus select in what vibration mode the protective cover 11 is to be vibrated. Next, the control circuit 32 sets the frequency of the drive signal to be applied to the piezoelectric element (S11). Specifically, the control circuit 32 sets a resonant frequency corresponding to the selected predetermined vibration mode and a frequency that is about 1/(2n+1) times the resonant frequency or about (2n+1) times the resonant frequency. Here, n is a positive integer. After setting the frequency of the drive signal, the control circuit 32 controls the drive signal to have the set frequency (S12). The excitation device 31 can thus apply the drive signal having the frequency based on the resonant frequency of the vibrator 17 to the piezoelectric element, and can vibrate the protective cover 11 in a predetermined vibration mode.

As described above, the excitation device 31 according to this example embodiment can realize the vibration device 10 having the function of removing foreign matter such as droplets adhering to the protective cover 11 and the function of causing the protective cover 11 to generate heat without changing the voltage value of the voltage applied to the piezoelectric element 15. The excitation device 31 can also vibrate the protective cover 11 in a vibration mode having a vibration distribution and a vibration amplitude according to the above functions, thus preventing accelerated decrease in the life of the coating of the protective cover 11.

In the example embodiment described above, the excitation device 31 vibrates the protective cover 11, which transmits the light detected by the imaging device 20, using the vibrating body 13 by driving the piezoelectric element 15, but the present disclosure is not limited thereto. For example, the vibration device 10 may include an object that is vibrated by the piezoelectric element 15 using the vibrating body 13, and the excitation device 31 may vibrate the object by driving the piezoelectric element 15. The object may be the light transmissive protective cover 11, for example, a translucent or opaque cover. The object is not particularly limited, and may be a component (for example, an optical component) from which dirt is preferably removed.

The excitation circuits, vibration devices, and vehicles described in the present disclosure are realized by, for example, cooperation of hardware resources, such as a processor and a memory, and software resources (computer programs).

Example embodiments of the present disclosure provide excitation devices, vibration devices, vehicles, control methods, and non-transitory media including computer programs that each execute a plurality of vibration modes to apply different vibrations to an object with a simple configuration. The example embodiments of the present disclosure are suitably applicable in these industrial fields.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An excitation device comprising:
an output circuit to output a drive signal including a frequency component to drive a piezoelectric element to vibrate an object using a vibrating body; and
a control circuit including a plurality of vibration modes to control the output circuit to apply to the piezoelectric element a drive signal with a frequency based on a resonant frequency of a vibrator including the object, the vibrating body, and the piezoelectric element; wherein
the plurality of vibration modes include a predetermined vibration mode in which the frequency of the drive signal is set to about 1/(2n+1) times or about (2n+1) times the resonant frequency of the vibrator; and
n is a positive integer.

2. The excitation device according to claim 1, wherein the frequency of the drive signal in the predetermined vibration mode is set so that the piezoelectric element causes the object to generate heat.

3. The excitation device according to claim 2, wherein the excitation device is configured to monotonically increase or decrease the frequency of the drive signal over time, in the predetermined vibration mode, under a condition that the frequency of the drive signal is about 1/(2n+1) times or about (2n+1) times the resonant frequency corresponding to the predetermined vibration mode.

4. The excitation device according to claim 1, wherein
the plurality of vibration modes include:
a first vibration mode in which the object is vibrated at a first vibration acceleration; and
a second vibration mode in which the object is vibrated at a second vibration acceleration that is smaller than the first vibration acceleration; and
the frequency of the drive signal in the second vibration mode is about 1/(2n+1) times or about (2n+1) times the frequency of the drive signal in the first vibration mode.

5. The excitation device according to claim 4, wherein
the first vibration acceleration is more than or equal to about 8.1×10⁵ m/s² and less than or equal to about 1.7×10⁶ m/s²; and
the second vibration acceleration is more than or equal to about 1.5×10⁵ m/s² and less than or equal to about 8.0×10⁵ m/s².

6. The excitation device according to claim 4, wherein
the control circuit includes a search mode to determine the resonant frequency of the vibrator;
when outputting the drive signal having a frequency of about 1/(2nₐ+1) times or about (2nₐ+1) times the resonant frequency corresponding to the first vibration mode, the drive signal having a frequency of about 1/(2n_{search}+1) times or about (2n_{search}+1) times the resonant frequency corresponding to the first vibration mode is outputted in the search mode;
nₐ is an integer greater than or equal to 0; and
n_{search} is a positive integer greater than nₐ.

7. The excitation device according to claim 1, wherein
the plurality of vibration modes include:
a first distribution mode in which the frequency of the drive signal in the predetermined vibration mode is set so that the object generates heat; and
a second distribution mode in which the object is vibrated at a predetermined vibration acceleration;
when v_{dist}=a_{center}/a_{edge}, then v_{dist_heat}>v_{dist_st} and a_{center_heat}<a_{center_st} are satisfied where v_{dist} is a distribution of vibration of the object, v_{dist_heat} is a distribution of vibration of the object in the first distribution mode, v_{dist_st} is a distribution of vibration of the object in the second distribution mode, a_{center} is an amplitude of a top portion of the object, a_{center_heat} is an amplitude of the top portion of the object in the first distribution mode, a_{center_st} is an amplitude of the top portion of the object in the second distribution mode, and a_{edge} is an amplitude of an end portion of the object.

8. The excitation device according to claim 7, wherein
the plurality of vibration modes further include:
a third distribution mode in which the object is vibrated with a vibration acceleration smaller than the predetermined vibration acceleration; and
v_{dist_heat}>v_{dist_we} is satisfied where v_{dist_we} is a distribution of vibration of the object in the third distribution mode.

9. The excitation device according to claim 1, wherein
the control circuit is operative to repeatedly perform an operation of changing the frequency of the drive signal in a predetermined frequency range determined based on the resonant frequency of the vibrator in each of the plurality of vibration modes;
the plurality of vibration modes include:
a first sweep mode in which the control circuit changes the frequency of the drive signal in a first frequency range including the frequency of the drive signal to drive the piezoelectric element so that the object generates heat, as the predetermined frequency range; and
a second sweep mode corresponding to a resonant frequency lower than a resonant frequency corresponding to the first sweep mode, in which the control circuit changes the frequency of the drive signal in a second frequency range as the predetermined frequency range; and
(HW1/SR1)>(HW2/SR2) is satisfied where HW1 is a half-value width of a peak at the resonant frequency in a displacement of the object within the first frequency range, SR1 is a width of the first frequency range, HW2 is a half-value width of a peak at the resonant frequency in a displacement of the object within the second frequency range, and SR2 is a width of the second frequency range.

10. The excitation device according to claim 9, further comprising:
a current detection circuit to detect a current based on a current flowing through the piezoelectric element and output a detection signal indicating a value based on the detected current to the control circuit; wherein
in each of the first sweep mode and the second sweep mode, the control circuit is operative to repeat an operation of changing the frequency of the drive signal within the predetermined frequency range, obtaining a change in the value of the detection signal with respect to the change in the frequency of the drive signal within the predetermined frequency range, and updating the resonant frequency of the vibrator based on a frequency at which the value of the detection signal reaches a maximum within the predetermined frequency range.

11. The excitation device according to claim 1, wherein the object includes a protective cover that is placed in front of an imaging device and transmits light detected by the imaging device.

12. A vibration device comprising:
the excitation device according to claim 1;
the piezoelectric element;
the vibrating body; and
the object.

13. The vibration device according to claim 12, wherein the frequency of the drive signal in the predetermined vibration mode is set so that the piezoelectric element causes the object to generate heat.

14. The vibration device according to claim 13, wherein the excitation device is configured to monotonically increase or decrease the frequency of the drive signal over time, in the predetermined vibration mode, under a condition that the frequency of the drive signal is about 1/(2n+1) times or about (2n+1) times the resonant frequency corresponding to the predetermined vibration mode.

15. The vibration device according to claim 12, wherein
the plurality of vibration modes include:
a first vibration mode in which the object is vibrated at a first vibration acceleration; and
a second vibration mode in which the object is vibrated at a second vibration acceleration that is smaller than the first vibration acceleration; and
the frequency of the drive signal in the second vibration mode is about 1/(2n+1) times or about (2n+1) times the frequency of the drive signal in the first vibration mode.

16. The vibration device according to claim 15, wherein
the first vibration acceleration is more than or equal to about 8.1×10⁵ m/s² and less than or equal to about 1.7×10⁶ m/s²; and
the second vibration acceleration is more than or equal to about 1.5×10⁵ m/s² and less than or equal to about 8.0×10⁵ m/s².

17. The vibration device according to claim 15, wherein
the control circuit includes a search mode to determine the resonant frequency of the vibrator;
when outputting the drive signal having a frequency of about 1/(2nₐ+1) times or about (2nₐ+1) times the resonant frequency corresponding to the first vibration mode, the drive signal having a frequency of about 1/(2n_{search}+1) times or about (2 n_{search}+1) times the resonant frequency corresponding to the first vibration mode is outputted in the search mode;
nₐ is an integer greater than or equal to 0; and
n_{search} is a positive integer greater than nₐ.

18. A vehicle comprising:
the excitation device according to claim 1;
the piezoelectric element;
the vibrating body;
the object; and
the imaging device.

19. A method for controlling an output circuit that outputs a drive signal including a frequency component to drive a piezoelectric element to vibrate an object using a vibrating body, the method comprising:
selecting a predetermined vibration mode from among a plurality of vibration modes to control the output circuit so as to apply to the piezoelectric element a drive signal having a frequency based on a resonant frequency of a vibrator including the object, the vibrating body, and the piezoelectric element; and
setting the frequency of the drive signal to about 1/(2n+1) times or about (2n+1) times the resonant frequency of the vibrator in the predetermined vibration mode; wherein
n is a positive integer.

20. A non-transitory computer-readable medium including a computer program to cause one or more processors to execute the control method according to claim 19.
